(19) United States
(12) Patent Application Publication
(10) Pub. No.: US 2025/0317255 A1
(43) Pub. Date: Oct. 9, 2025

(54) RATE MATCHING TECHNIQUES FOR TRANSPORT BLOCK PROCESSING OVER MULTIPLE SLOTS WITH ORTHOGONAL COVER CODES

(71) Applicant: QUALCOMM Incorporated, San Diego, CA (US)

(72) Inventors: Syed Hashim Ali SHAH, San Diego, CA (US); Alberto RICO ALVARINO, San Diego, CA (US); Xiao Feng WANG, San Diego, CA (US); Ayan SENGUPTA, San Diego, CA (US); Liangping MA, San Diego, CA (US)

(21) Appl. No.: 19/098,866

(22) Filed: Apr. 2, 2025

Related U.S. Application Data
(60) Provisional application No. 63/574,555, filed on Apr. 4, 2024.

(51) Int. Cl. H04L 5/00; H04W 72/21

(52) U.S. Cl. CPC H04L 5/0053; H04W 72/21

(57) ABSTRACT

Methods, systems, and devices for wireless communications are described. A UE may select coded information bits based on an orthogonal cover code (OCC) multiplexing order and/or a type of OCC multiplexing. For example, the UE may receive a control message that indicates the OCC multiplexing order and/or the type of OCC multiplexing. The UE may select encoded bits from a buffer for an uplink transmission, where a quantity of encoded bits selected for each slot of the uplink transmission may be scaled based on a total quantity of bits per slot and the OCC multiplexing order. Additionally, or alternatively, the UE may scale the bit selection based on a unit (e.g., a slot, cluster, symbol, resource element) of the transmission, where, for each unit of a set of units, the UE may select bits from the buffer a quantity of times that corresponds to the OCC multiplexing order.

### FIELD OF TECHNOLOGY

The Present Application for Patent claims the benefit of U.S. Provisional Patent Application No. 63/574,555 by Shah et al., entitled “RATE MATCHING TECHNIQUES FOR TRANSPORT BLOCK PROCESSING OVER MULTIPLE SLOTS WITH ORTHOGONAL COVER CODES,” filed Apr. 4, 2024, assigned to the assignee hereof, and expressly incorporated by reference in its entirety herein.

### FIELD OF TECHNOLOGY

The following relates to wireless communications, including rate matching techniques for transport block processing over multiple slots (TBoMS) with orthogonal cover codes (OCC).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support rate matching techniques for transport block processing over multiple slots (TBoMS) with orthogonal cover codes (OCCs). For example, the described techniques enable a user equipment (UE) to select coded information bits based on an OCC multiplexing order and a type of OCC multiplexing. In some aspects, the UE may receive one or more control messages from a network entity, where the one or more control messages may indicate an OCC multiplexing order and/or a type of OCC multiplexing. For a set of source information bits associated with an uplink transmission, the UE may perform channel coding to obtain a set of encoded information bits (e.g., which may be referred to as encoded bits and/or coded bits), which may be stored in a buffer of the UE. The UE may select, from the buffer, a quantity of bits for respective transmission time intervals (e.g., respective slots) associated with the uplink transmission. For example, the UE may select, for each slot of a set of multiple slots, a quantity of encoded bits for the uplink transmission, where the quantity of bits for each transmission time interval (e.g., each slot) selected from the buffer may be based on respective starting encoded bits (e.g., respective indices of starting encoded bits). In such cases, the respective starting encoded bit may be based on a total quantity of encoded bits for each transmission time interval (e.g., slot) and the OCC multiplexing order. In some aspects, OCC repetitions in accordance with the type of OCC multiplexing and OCC multiplexing order may be achieved during resource mapping (e.g., to time/frequency resources) prior to sending the uplink transmission.

Additionally, or alternatively, the UE may select a quantity of encoded bits for a set of multiple units (e.g., slots, symbols, clusters, resource elements (REs), or the like) associated with the uplink transmission. In such cases, for each unit of the set of units, a respective quantity of encoded bits may be selected a quantity of times that corresponds to the OCC multiplexing order. Here, the respective starting encoded bit for the encoded bits stored in the buffer may advance after the respective quantity of encoded bits is selected the quantity of times corresponding to the OCC multiplexing order (e.g., for an OCC multiplexing order M, the index of the starting encoded bit may only advance after bits have been selected from the buffer M times (e.g., for M units)). Here, the OCC repetitions may be achieved based on the selection of the quantity of encoded bits for the set of multiple units.

In any case, the UE may transmit the uplink transmission to a network entity. The uplink transmission may include one or more repetitions of each respective quantity of encoded bits based on the respective quantities of encoded bits in accordance with the type of OCC multiplexing and an OCC codeword assignment.

A method for wireless communications by a UE is described. The method may include receiving, from a network entity, a control message indicating an OCC multiplexing order, a type of OCC multiplexing, or both, selecting a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order, and transmitting the uplink shared channel transmission to the network entity, where the uplink shared channel transmission includes one or more repetitions of the quantity of encoded bits via the set of multiple slots based on the type of OCC multiplexing and an OCC codeword assignment.

A UE for wireless communications is described. The UE may include one or more memories storing processor executable code, and one or more processors coupled with the one or more memories. The one or more processors may individually or collectively be operable to execute the code to cause the UE to receive, from a network entity, a control message indicating an OCC multiplexing order, a type of OCC multiplexing, or both, select a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order, and transmit the uplink shared channel transmission to the network entity, where the uplink shared channel transmission includes one or more repetitions of the quantity of encoded bits via the set of multiple slots based on the type of OCC multiplexing and an OCC codeword assignment.

Another UE for wireless communications is described. The UE may include means for receiving, from a network entity, a control message indicating an OCC multiplexing order, a type of OCC multiplexing, or both, means for selecting a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order, and means for transmitting the uplink shared channel transmission to the network entity, where the uplink shared channel transmission includes one or more repetitions of the quantity of encoded bits via the set of multiple slots based on the type of OCC multiplexing and an OCC codeword assignment.

A non-transitory computer-readable medium storing code for wireless communications is described. The code may include instructions executable by one or more processors to receive, from a network entity, a control message indicating an OCC multiplexing order, a type of OCC multiplexing, or both, select a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order, and transmit the uplink shared channel transmission to the network entity, where the uplink shared channel transmission includes one or more repetitions of the quantity of encoded bits via the set of multiple slots based on the type of OCC multiplexing and an OCC codeword assignment.

In some examples of the method, UEs, and non-transitory computer-readable medium described herein, the quantity of encoded bits for each slot may be interleaved and the method, apparatuses, and non-transitory computer-readable medium may include further operations, features, means, or instructions for mapping the interleaved, scrambled, and modulated quantity of encoded bits to one or more resources associated with each slot of the set of multiple slots based on the type of OCC multiplexing, where the one or more repetitions may be based on the mapping.

Some examples of the method, UEs, and non-transitory computer-readable medium described herein may further include operations, features, means, or instructions for applying an OCC codeword to obtain a quantity of the one or more repetitions that corresponds to the OCC multiplexing order, where the OCC codeword may be based on the OCC codeword assignment.

Some examples of the method, UEs, and non-transitory computer-readable medium described herein may further include operations, features, means, or instructions for determining an index of each respective starting encoded bit based on dividing the total quantity of encoded bits allocated in a slot by the OCC multiplexing order, where the quantity of encoded bits may be selected based on the index of each respective starting encoded bit.

In some examples of the method, UEs, and non-transitory computer-readable medium described herein, the index of each respective starting encoded bit may be calculated based on a redundancy version index, the total quantity of encoded bits allocated in a slot, the OCC multiplexing order, and a quantity of filler bits.

Some examples of the method, UEs, and non-transitory computer-readable medium described herein may further include operations, features, means, or instructions for selecting the quantity of bits for each slot may be based on counting the set of multiple slots.

Some examples of the method, UEs, and non-transitory computer-readable medium described herein may further include operations, features, means, or instructions for transmitting, to the network entity, a capability message indicating one or more capabilities of the UE to support orthogonal cover code multiplexing, where receiving the control message may be based on the one or more capabilities.

Some examples of the method, UEs, and non-transitory computer-readable medium described herein may further include operations, features, means, or instructions for determining the OCC codeword assignment based on a mapping between a demodulation reference signal identifier and the OCC codeword assignment and determining the OCC multiplexing order based on the OCC codeword assignment.

In some examples of the method, UEs, and non-transitory computer-readable medium described herein, the control message indicates both the OCC multiplexing order and the type of OCC multiplexing.

In some examples of the method, UEs, and non-transitory computer-readable medium described herein, the type of OCC multiplexing includes a slot-based OCC type, a symbol-based OCC type, a cluster-based OCC type, a frequency-domain OCC type, a time-domain OCC type, a sub-physical resource block (PRB) OCC type, or any combination thereof.

In some examples of the method, UEs, and non-transitory computer-readable medium described herein, a set of multiple encoded bits from which the quantity of encoded bits for each slot may be selected may be associated with a circular buffer of the UE.

A method for wireless communications by a UE is described. The method may include receiving, from a network entity, a control message indicating an OCC multiplexing order, a type of OCC multiplexing, or both, selecting a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit, and transmitting the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment.

A UE for wireless communications is described. The UE may include one or more memories storing processor executable code, and one or more processors coupled with the one or more memories. The one or more processors may individually or collectively be operable to execute the code to cause the UE to receive, from a network entity, a control message indicating an OCC multiplexing order, a type of OCC multiplexing, or both, select a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit, and transmit the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment.

Another UE for wireless communications is described. The UE may include means for receiving, from a network entity, a control message indicating an OCC multiplexing order, a type of OCC multiplexing, or both, means for selecting a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit, and means for transmitting the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment.

A non-transitory computer-readable medium storing code for wireless communications is described. The code may include instructions executable by one or more processors to receive, from a network entity, a control message indicating an OCC multiplexing order, a type of OCC multiplexing, or both, select a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit, and transmit the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment.

In some examples of the method, UEs, and non-transitory computer-readable medium described herein, the quantity of encoded bits for each slot is interleaved, scrambled, and modulated after the quantity of encoded bits is selected, and the method, UEs, and non-transitory computer-readable medium may include further operations, features, means, or instructions for scaling the respective sets of modulated symbols associated with each respective quantity of encoded bits using an OCC codeword that may be based on the OCC codeword assignment, where the one or more repetitions may be based on the scaling.

In some examples of the method, UEs, and non-transitory computer-readable medium described herein, the interleaving and the scrambling may be unaltered when the respective starting encoded bit advances after the respective quantity of encoded bits may be selected the quantity of times corresponding to the OCC multiplexing order.

Some examples of the method, UEs, and non-transitory computer-readable medium described herein may further include operations, features, means, or instructions for advancing an index of each respective starting encoded bit based on selecting the respective quantity of encoded bits for each unit, where the index may be advanced after the respective quantities of encoded bits for a quantity of units corresponding to the OCC multiplexing order may be selected.

Some examples of the method, UEs, and non-transitory computer-readable medium described herein may further include operations, features, means, or instructions for determining the index of each respective starting encoded bit based on a redundancy version index, a total quantity of encoded bits, the OCC multiplexing order, a quantity of filler bits, an index of the unit, or any combination thereof.

Some examples of the method, UEs, and non-transitory computer-readable medium described herein may further include operations, features, means, or instructions for transmitting, to the network entity, a capability message indicating one or more capabilities of the UE to support orthogonal cover code multiplexing, where receiving the control message may be based on the one or more capabilities.

Some examples of the method, UEs, and non-transitory computer-readable medium described herein may further include operations, features, means, or instructions for determining the OCC codeword assignment based on a mapping between a demodulation reference signal identifier and the OCC codeword assignment and determining the OCC multiplexing order based on the OCC codeword assignment.

In some examples of the method, UEs, and non-transitory computer-readable medium described herein, the control message indicates both the OCC multiplexing order and the type of OCC multiplexing.

Some examples of the method, UEs, and non-transitory computer-readable medium described herein may further include operations, features, means, or instructions for selecting the respective quantity of encoded bits for each unit may be based on counting each unit of the set of multiple units.

In some examples of the method, UEs, and non-transitory computer-readable medium described herein, each unit includes a slot, a cluster, a symbol, a resource element, or any combination thereof.

In some examples of the method, UEs, and non-transitory computer-readable medium described herein, each unit may be based on the type of OCC multiplexing.

In some examples of the method, UEs, and non-transitory computer-readable medium described herein, the type of OCC multiplexing includes a slot-based OCC type, a symbol-based OCC type, a cluster-based OCC type, a frequency-domain OCC type, a time-domain OCC type, a sub-PRB OCC type, or any combination thereof.

In some examples of the method, UEs, and non-transitory computer-readable medium described herein, a set of multiple encoded bits from which the quantity of encoded bits for each unit may be selected may be associated with a circular buffer of the UE.

### BRIEF DESCRIPTION OF THE DRAWINGS

FIG. 1 shows an example of a wireless communications system that supports rate matching techniques for transport block processing over multiple slots (TBoMS) with orthogonal cover codes (OCCs) in accordance with one or more aspects of the present disclosure.

FIG. 2 shows an example of a wireless communications system that supports rate matching techniques for TBoMS with OCCs in accordance with one or more aspects of the present disclosure.

FIG. 3 shows an example of a circular buffer diagram that supports rate matching techniques for TBoMS with OCCs in accordance with one or more aspects of the present disclosure.

FIG. 4 shows an example of a circular buffer diagram that supports rate matching techniques for TBoMS with OCCs in accordance with one or more aspects of the present disclosure.

FIG. 5 shows an example of a transmission diagram that supports rate matching techniques for TBoMS with OCCs in accordance with one or more aspects of the present disclosure.

FIGS. 6A, 6B, 6C, and 6D show respective examples of calculators that support rate matching techniques for TBoMS with OCCs in accordance with one or more aspects of the present disclosure.

FIG. 7 shows an example of a process flow that supports rate matching techniques for TBoMS with OCCs in accordance with one or more aspects of the present disclosure.

FIGS. 8 and 9 show block diagrams of devices that support rate matching techniques for TBoMS with OCCs in accordance with one or more aspects of the present disclosure.

FIG. 10 shows a block diagram of a communications manager that supports rate matching techniques for TBoMS with OCCs in accordance with one or more aspects of the present disclosure.

FIG. 11 shows a diagram of a system including a device that supports rate matching techniques for TBoMS with OCCs in accordance with one or more aspects of the present disclosure.

FIGS. 12 through 15 show flowcharts illustrating methods that support rate matching techniques for TBoMS with OCCs in accordance with one or more aspects of the present disclosure.

### DETAILED DESCRIPTION

One or more user equipments (UEs) may apply one or more techniques that result in transmitting uplink repetitions. For example, the one or more UEs may apply orthogonal cover code (OCC) multiplexing by scaling a quantity of information bits over one or more resources, which may be based on a quantity of UEs that are transmitting on the same resources (e.g., an OCC multiplexing order). In addition, the one or more UEs may perform transport block processing over multiple slots (TBoMS) techniques, resulting in a relatively greater quantity of uplink repetitions, where respective transmission time intervals (e.g., slots) may be bundled together within a transmission. Further, one or more transmissions by the UE may be associated with respective redundancy versions. To account for the scaling associated with OCC multiplexing techniques when used in combination with TBoMS techniques (e.g., along with one or more redundancy versions of a transmission), it may be desirable to define techniques to ensure appropriate rate matching of encoded bits for TBoMS with OCC.

The techniques described herein may enable a UE to select coded information bits based on an OCC multiplexing order and a type of OCC multiplexing. As such, the UE may use various techniques for selecting bits from a circular buffer (e.g., for performing rate matching) to achieve repetitions for OCC in one or more uplink transmissions. In a first example, a UE may scale a quantity of bits selected for each slot of the uplink transmission using the OCC multiplexing order. The total quantity of bits per slot may be divided by the OCC multiplexing order to determine a starting coded bit for each slot (e.g., an index of a bit to be selected at the start of each slot). In such cases, the UE may achieve OCC repetitions of bits by mapping the bits (e.g., after interleaving, scrambling, and modulation) to physical resources in accordance with the OCC multiplexing order (and using an OCC codeword). Thus, the described techniques may result in changes to both rate matching (e.g., by a bit selector) and to resource mapping performed by the UE.

In a second example, the UE may scale the bit selection based on a unit (e.g., a slot, a cluster of resources, a symbol period, a resource element (RE), or the like) that may correspond to an OCC multiplexing type. Here, for each unit of a set of units, the UE may select bits from the circular buffer a quantity of times that corresponds to the OCC multiplexing order. For instance, when OCC is applied across slots, the starting encoded bit used for selecting bits from the circular buffer may not be advanced (e.g., the index of the respective starting encoded bit does not change) until M slots have passed, where M is the OCC multiplexing order. During each of the M traversals of the buffer, the UE may apply a scaling to the modulation symbols associated with the bits (e.g., based on interleaving, scrambling, and modulation of the selected encoded bits for the unit). The UE may scale the modulation symbols based on the OCC codeword used at the UE (e.g., assigned to the UE). Such techniques may be associated with changes to rate matching performed by the UE.

Aspects of the disclosure are initially described in the context of wireless communications systems. Aspects of the disclosure are then described with reference to circular buffer diagrams, a transmission diagram, calculators, and a process flow. Aspects of the disclosure are further illustrated by and described with reference to apparatus diagrams, system diagrams, and flowcharts that relate to rate matching techniques for TBoMS with/using OCCs.

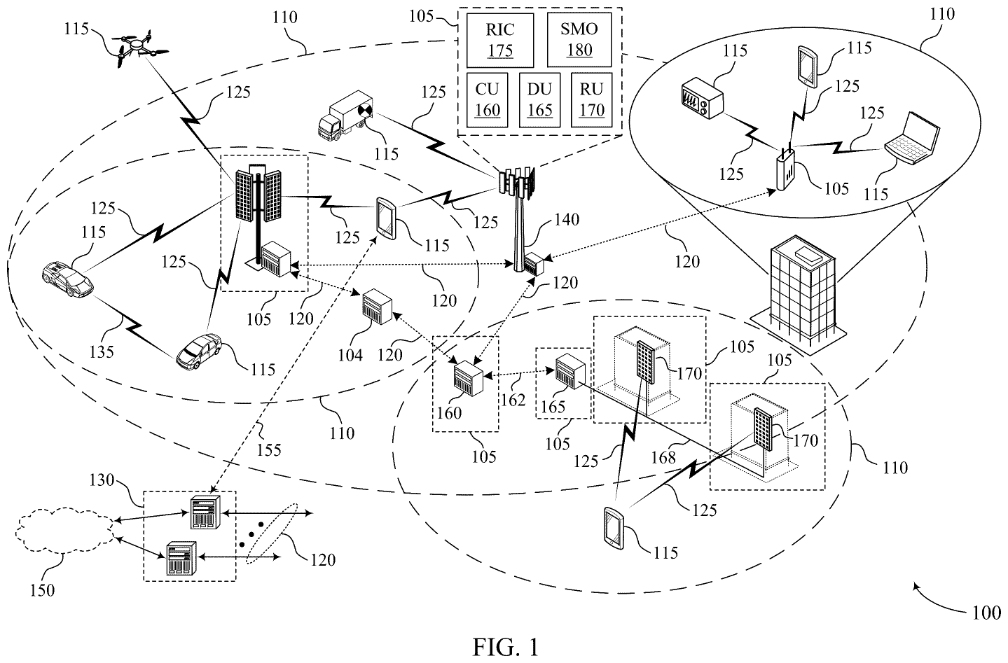

FIG. 1 shows an example of a wireless communications system 100 that supports rate matching techniques for TBoMS with OCCs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different Rus, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs 115) or may include UE-specific search space sets for sending control information to a UE 115 (e.g., a specific UE 115).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Wireless communications system 100 may support multiple-access schemes to multiplex multiple UEs 115. Thus, the multiple UEs 115 may be allocated a same set of time-frequency resources (e.g., packing the multiple UEs 115 in a same amount of time-frequency resources). In some cases, multiplexing UEs 115 may create interference at a base station. Some wireless communications systems may apply orthogonal cover codes (OCCs) to mitigate interference. For example, the multiple UEs 115 may apply a cover code (e.g., an OCC) to a set of data. The network entity 105 may decode the cover coded data from each UE 115 of the multiple UEs 115 based on the respective codeword used by each UE 115. Due to a repetitive nature of uplink transmissions in non-terrestrial networks (NTNs), a wireless communications system, such as an NTN, may support uplink transmission using OCC with a lower resource cost compared to transmission using code division multiple access (CDMA). An orthogonal frequency division multiplexing (OFDM) grid structure that supports different types of resource allocations may support applying OCCs using one or more different techniques. The OFDM grid structure may also support TBoMS.

In accordance with an OCC scheme with an OCC factor M (e.g., a spreading factor, an OCC multiplexing order), each UE 115 of a set of UEs 115 may transmit a set of one or more uplink messages via a respective set of resource entities. A resource element may be represented by a symbol sᵢ^{j}, indicating a resource element j at UE i. For example, a first UE 115 may spread a resource element s₁⁰ across multiple resource elements, or spread entities, according to a first OCC assigned to the first UE 115. The first OCC may be represented by a vector [1, 1] in accordance with an OCC factor M equal to two. Thus, the first UE 115 may transmit two OCC repetitions over spread entities s₁⁰ and s₁⁰ (e.g., across multiple slots in a time domain, or across multiple tones in a frequency domain). Similarly, a second UE 115 may spread a resource element s₂⁰ across multiple resource elements according to a second OCC assigned to the second UE 115. The second OCC may be represented by a vector [1,−1] in accordance with the OCC factor M equal to two. Thus, the second UE 115 may transmit two OCC repetitions over spread entities s₂⁰ and −s₂⁰. Such techniques may allow the first UE 115 and the second UE 115 to transmit uplink messages on a same set of time-frequency resources (e.g., since the spread entities used by each UE 115 are orthogonal to each other, a receiving device such as a network entity may distinguish the uplink messages).

In some examples, two or more UEs 115 may apply similar principles to transmit uplink messages on a same set of time frequency resources. For example, four UEs 115 may apply such techniques for an OCC factor M (e.g., an OCC multiplexing order) equal to four. In some cases, a set of UEs 115 including a first UE 115, a second UE 115, a third UE 115, and a fourth UE 115 may be assigned an OCC. For example, OCCs codewords [1, 1, 1, 1], [1,−1, 1,−1], [1, 1,−1,−1], [1,−1,−1, 1] may be assigned to each UE 115 of the set of UEs 115, respectively. In such an example, the first UE 115 may transmit four OCC repetitions over spread entities s°, s), s), and s), in accordance with the first OCC codeword [1, 1, 1, 1]. The second UE 115 may transmit four OCC repetitions over spread entities s₂⁰, −s₂⁰, s₂⁰, and −s₂⁰, in accordance with the second OCC codeword [1,−1, 1,−1]. The third UE 115 may transmit four OCC repetitions over spread entities s₃⁰, s₃⁰, −s₃⁰, and −s₃⁰, in accordance with the third OCC codeword [1, 1, −1, −1]. The fourth UE 115 may transmit four OCC repetitions over spread entities s₄⁰, −s₄⁰, −s₄⁰, and s₄⁰, in accordance with the fourth OCC codeword [1,−1,−1, 1]. The described techniques may be applied to any quantity of UEs 115 (e.g., more than one UE 115, more than two UEs 115, more than four UEs 115, and so forth), and these examples should not be considered limiting to the scope of the claims or the disclosure.

In wireless communications system 100, one or more UEs may perform a cluster-wise OCC according on one or more uplink messages. In some cases, a resource element may be represented by a symbol s; (k, t), indicating a frequency resource k and a symbol i at a UE i. A first UE 115 and a second UE 115 may perform an OCC (e.g., a cluster-wise OCC) across a cluster including a quantity of symbols (e.g., OFDM symbols). For example, for a cluster with length 2 symbols, the first UE 115 may apply the OCC to transmit a first cluster of symbols. The first cluster may include two symbols on each of a set of frequency resources (e.g., 12 frequency resources), represented by resource elements s₁ (12,1), s₁(12,2), s₁(11,1), s₁ (11,2) . . . s₁ (1,1), and s₁ (1,2). The first UE 115 may expand the first cluster across M clusters, where M is a multiplexing order of the OCC. For M=2, the first UE 115 may expand the first cluster across two clusters (e.g., expanding the two symbols of each frequency resource across four symbols of each frequency resources). For example, the first UE 115 may transmit two repetitions or copies of the first cluster in accordance with a first OCC of an OCC configuration or scheme (e.g., [1, 1]). In some cases, a cluster may correspond to one or more time/frequency resources that are grouped together, such as one or more REs, one or more OFDM symbols, and the like.

The second UE 115 may apply the OCC to transmit a second cluster of symbols. The second cluster may include two symbols on each of a set of frequency resources, represented by resource elements s₂(12,1), s₂(12,2), s₂(11,1), s₂(11,2) . . . . s₂(1,1), and s₂(1,2). The second UE 115 may expand the second cluster across two clusters (e.g., expanding the two symbols of each frequency resource across four symbols of each frequency resources). For example, the second UE 115 may transmit two repetitions or copies of the second cluster, where one set of resource elements is inverted, in accordance with a second OCC of an OCC configuration or scheme (e.g., [1,−1]). Based on the second OCC, the inverted set of resource elements may include −s₂ (12,1), −s₂(12,2), −s₂(11,1),−s₂ (11,2) . . . s₂(1,1), and −s₂ (1,2). Thus, for a UE 115 applying a cluster-wise OCC, the UE 115 may transmit expand a cluster across M clusters (e.g., a quantity of clusters equal to the multiplexing order of the OCC). As described herein, a cluster may refer to a group of one or more resource elements, a group of symbols (e.g., a “mini-slot”), a slot, or multiple slots. The group of symbols may be adjacent (e.g., in a time domain) or the group of symbols may be separate.

In wireless communications system 100, a UE 115 may perform rate matching on a set of information bits. For example, after channel coding, the UE 115 may store the set of information bits in a circular buffer. The UE 115 may select, using a bit selector, which bits of the circular buffer are to be transmitted in a particular transmission. In another perspective (e.g., on a higher level of abstraction), the bit selector may indicate to a system (e.g., the UE 115) where to begin selecting bits and how many bits to select. This process may be referred to as rate matching. In some cases, the UE 115 may use a same circular buffer in multiple transmissions to send different redundancy versions (RVs) of data.

During a transmission process, the UE 115 may encode source bits into information bits, where a quantity of source bits may be smaller than a quantity of information bits. The UE 115 may store the information bits into a circular buffer. The UE 115 may transmit the information bits over one or multiple transmissions (e.g., using the bit selector for rate matching). For example, if a total quantity of information bits in the circular buffer is 2000 bits, the UE 115 may transmit the 2000 information bits one transmission, assuming the UE 115 has sufficient resources for such a transmission. The bit selector may select a subset of bits to transmit for each transmission of a set of transmissions. In some cases, if the UE 115 has sufficient resources for 500 bits per transmission, the UE 115 may transmit the 2000 information bits over four transmissions. In such cases, the bit selector of the UE 115 may begin by selecting a first set of 500 bits for a first transmission. The bit selector may then advance the circular buffer pointer by 500 (e.g., after the first transmission) to prepare for a second transmission. The bit selector may then select a second set of 500 bits for the second transmission, and the UE 115 may subsequently transmit the second set of 500 bits, and so on. Additionally, or alternatively, the UE 115 may transmit the 2000 bits twice (e.g., for a transmission with an OCC corresponding to an OCC factor of two). If the UE 115 has sufficient resources for 500 bits per transmission, the UE 115 may transmit the 2000 bits over four transmissions and may transmit a copy of the 2000 bits over four more transmissions, resulting in eight total transmissions. After bit selection, the UE 115 may interleave the bits, scramble the bits, modulate the bits into symbols, and map the bits onto resources (e.g., time-frequency resources).

However, for uplink transmissions for OCC, the UE 115 may use relatively more resources to carry a same quantity of modulated symbols (e.g., for an OCC factor or spreading factor M, one symbol has to be repeated M times). Thus, the UE 115 may reduce a quantity of generated modulated symbols by a factor of M. In some cases, the UE 115 may reduce a quantity of coded bits by a factor of M to reduce the quantity of generated modulated symbols. In some examples, the UE 115 may modify a bit selector of the UE 115. For example, the UE 115 may select bits, using the bit selector, from a circular buffer in accordance with an OCC scheme and may calibrate (e.g., recalibrate) a circular buffer pointer associated with the circular buffer in accordance with the OCC scheme. Additionally, or alternatively, the UE 115 may modify a resource mapper of the UE 115. For example, the UE 115 may modify the resource mapper based on the OCC scheme, to comply with a system using TBoMS, or both.

The wireless communications system 100 may support TBoMS transmission by applying RV cycling and bit selection without applying an OCC. For example, the wireless communications system may support TBoMS transmission across eight slots. Each TBoMS repetition may have or may be associated with a set of two or more slots, such as four slots (e.g., there may be two TBoMS repetitions, each having four slots, totaling eight slots). In such examples, each set of four slots may be associated with a single RV, and the single RV associated with each respective set of four slots may change across multiple repetitions (e.g., a next TBoMS repetition).

An index of a starting coded bit in a circular buffer (or a pointer of the circular buffer) for a slot n of a single TBoMS (e.g., κₙ) may be calculated according to Equation (1):

$${κ}_{n} = \{ \begin{matrix}{k}_{0} & n = 0 \\ ( {κ}_{n - 1} + H + {τ}_{n - 1} ) mod {N}_{cb} & n = 1 , … , N - 1\end{matrix} \qquad ( 1 )$$

where k₀ is determined based on an RV index; H is a total quantity of coded bits available for transmission of the transport block in a slot allocated for TBoMS assuming no uplink control information (UCI) multiplexing; and where τₙ₋₁ is a quantity of filler bits that may be skipped in a bit selection step, assuming no UCI multiplexing, in the slot (n−1) allocated for TBoMS.

The wireless communications system 100 may support TBoMS using a repetition structure. For example, the repetition structure may include viewing a collection of N slots as a single transmission, scaling a transport block size by a factor of N, refreshing an RV once every N slots, and mapping coded bits from the circular buffer continuously across the N slots. Thus, the repetition structure may include two levels of repetition, including a first level, including RV cycling, and a second level, including TBoMS (e.g., bundling multiple slots within an RV). A wireless communications system applying OCC may cover code an original data set into M copies of the original data set. The M copies may have different scaling of phase, amplitude, or both. Thus, applying cover codes (e.g., OCCs) may be considered a level of repetition (e.g., a third level of repetition) in systems that use OCC. In some cases, to achieve potential improvements offered by OCC, a wireless communications system may apply rate matching, while considering OCC-level repetitions (e.g., applying rate matching that is appropriate for transmission with OCCs). A first UE 115 of the wireless communications system 100 may apply a slot-wise OCC for uplink transmission. For example, the first UE 115 may apply the OCC across multiple slots here (e.g., one slot may be expanded across two or more slots). In some cases, the first UE 115 may use a codeword (e.g., and OCC) [1, 1], while a second UE 115 may use a codeword [1,−1]. Thus, the first UE 115 and the second UE 115 may transmit uplink messages on a same set of time-frequency resources while reducing interference (e.g., since the respective codewords are orthogonal). The first UE 115 and the second UE 115 may apply similar techniques with other configurations of OCC (e.g., frequency domain OCC (FD-OCC), time domain OCC (TD-OCC), cluster-wise OCC, and so on).

After applying an OCC, a repetition structure may include three levels of repetition. For example, the repetition structure may include a first level, including RV cycling, a second level, including TBoMS, or bundling multiple slots within an RV, and a third level, which includes OCC repetitions (e.g., cover coded copies) within TBoMS. For a wireless communications system that applies OCCs, a quantity of information bits within a TBoMS repetition may be calculated according to Equation (2):

$${N}_{info} = \frac{N}{M} * {N}_{RE} * R * {Q}_{m} * v \qquad ( 2 )$$

where N_{RE} is a total quantity of REs allocated to a physical uplink shared channel (PUSCH), R is a coding rate, Qₘ is a modulation order, v is a quantity of layers, N is a quantity of slots for TBoMS, and M is an OCC multiplexing order (e.g., a spreading factor). A device (e.g., a UE 115 or a network entity) may determine a size of a transport block (e.g., a TBSize) based on N_{info} either from a table or an equation (e.g., Equation (2)). In some cases, such techniques may reduce the quantity of bits in a singular RV (e.g., by about a factor of M, by a factor of M). In some examples, a duration of an uplink transmission may not change as result of applying OCCs (e.g., OCC spreading). Thus, solutions to define how to traverse a circular buffer for systems applying the three levels of repetition (e.g., RV cycling, TBoMS, OCC) are desirable. As described herein, traversing a circular buffer may refer to reading bits, or information, from the circular buffer (e.g., reading a segment or portion of the circular buffer one or more times, advancing a pointer associated with the circular buffer, and reading a next segment or portion of the circular buffer).

The techniques described herein may enable a UE 115 to select coded information bits based on an OCC multiplexing order and a type of OCC multiplexing. A UE 115 may apply changes to how bits are selected from a circular buffer and how repetitions are achieved in an uplink transmission in accordance with two alternatives.

In a first example, a UE 115 may scale a quantity of bits selected for each slot of the uplink transmission using the OCC multiplexing order. The total quantity of bits may be divided by the OCC multiplexing order to determine a starting coded bit for each slot. In such cases, the UE 115 may transmit the repetitions of bits by mapping the bits to physical resources in accordance with the OCC multiplexing order. Thus, the described techniques may result in changes to both rate matching and to resource mapping. In a second example, the UE 115 may scale the bit selection based on a unit such as a slot, a group of symbols, or the like. For each unit of a set of units, the UE 115 may select bits from the circular buffer a quantity of times that corresponds to the OCC multiplexing order. As an illustrative example, when OCC is applied across slots, the circular buffer is not advanced until M slots have passed, where M is the OCC multiplexing order. During each of the M traversals of the buffer, the UE 115 may apply a scaling to the symbols associated with the bits. The UE 115 may scale the symbols (or other units) based on the OCC codeword used at the UE 115. Such techniques may be associated with changes to rate matching performed by the UE 115.

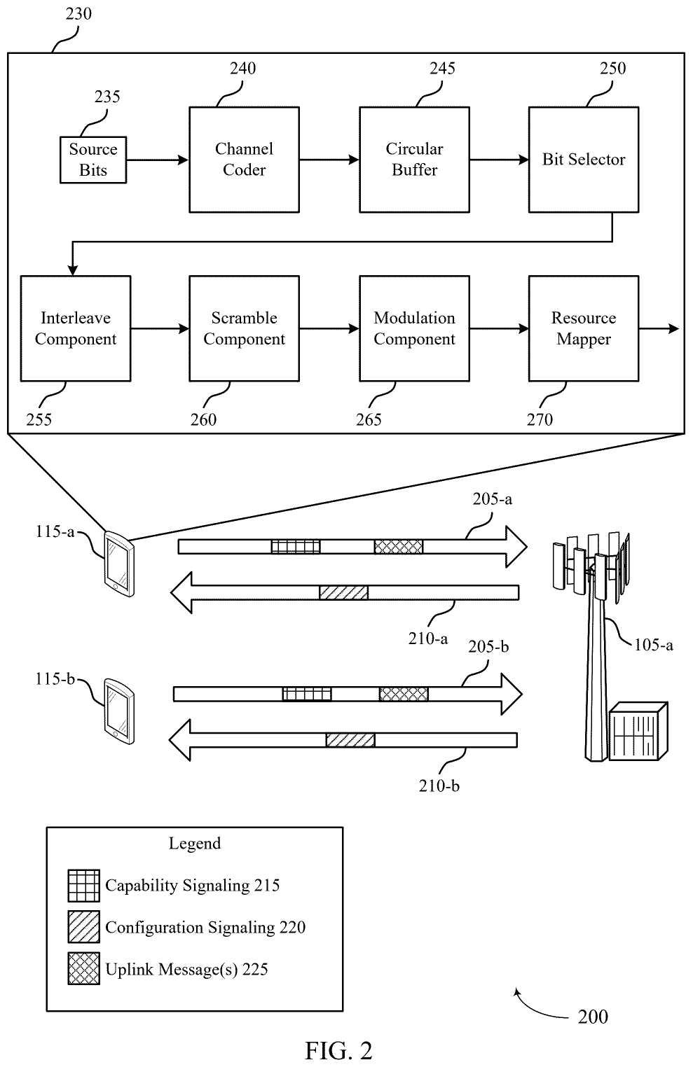

FIG. 2 shows an example of a wireless communications system 200 that supports rate matching techniques for TBoMS with OCCs in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a and a UE 115-b) and one or more network entities 105 (e.g., a network entity 105-a), which may be examples of the corresponding devices as described herein. The UE 115-a may transmit, to the network entity 105-a, uplink signaling via an uplink connection 205-a (e.g., a PUSCH, a physical uplink control channel (PUCCH), or both). The UE 115-a may receive, from the network entity 105-a, downlink signaling via a downlink connection 210-a (e.g., a physical downlink shared channel (PDSCH), a physical downlink control channel (PDCCH), or both). Similarly, the UE 115-b may transmit uplink signaling (e.g., one or more uplink messages 225, which may be referred to as uplink shared channel transmission, or similar terminology) via an uplink connection 205-b and may receive downlink signaling via a downlink connection 210-b. In the following description, although some operations are described to be performed by the UE 115-a, these operations may also be performed by the UE 115-b in some examples.

In some implementations, the UE 115-a may transmit, to the network entity 105-a, capability signaling 215. The capability signaling 215 may indicate that the UE 115-a supports multiplexing with an OCC. The capability signaling 215 may be based on phase coherence capabilities associated with the UE 115-a. In some cases, the UE may receive, from the network entity 105-a, configuration signaling 220 (e.g., via radio resource control (RRC) signaling or medium access control-control element (MAC-CE) signaling). The configuration signaling 220 may include a configuration that includes parameters (e.g., details) associated with an OCC that the UE 115-a is to use for uplink transmission. For example, the parameters associated with the OCC may include a multiplexing order M that is based on the capability signaling 215 (e.g., the phase coherence capabilities reported from UE 115-a). Additionally, or alternatively, the configuration signaling 220 may indicate a type of the OCC that the UE 115-a is to use for uplink transmission (e.g., slot-wise, cluster-wise, FD-OCC, TD-OCC, sub-physical-resource-block (sub-PRB) OCC, or another OCC type). In some examples, the configuration signaling 220 may indicate one or more parameters of the OCC such as a quantity of clusters for a cluster-wise OCC.

In some cases, the configuration signaling 220 may assign a first OCC codeword that the UE 115-a may use for uplink transmission. Similarly, the network entity 105-a may assign a second OCC codeword that the UE 115-b may use for uplink transmission (e.g., the network entity 105-a may assign respective OCC codewords to multiple UEs 115 for multiplexing). In some cases (e.g., if the UE 115-a does not receive a grant for communications from the network entity 105-a), the network entity 105-a may indicate a codeword assignment to each UE 115 via a system information block (SIB).

In some implementations, a DMRS ID may be valid for transmissions in which the UE 115-a does not receive a grant for communications from the network entity 105-a (e.g., the UE 115-a may not be in a connected mode). For example, the UE 115-a may perform communication procedures such as a random access small data transmission (RA-SDT), an early data transmission (EDT), or both. In some cases, such as if the UE 115-a performs these communication procedures, the UE 115-a may determine to transmit a preamble and may transmit data to the network entity 105-a (e.g., based on receiving the SIB from the network entity 105-a). The preamble (e.g., selected by the UE 115-a) may be mapped to a particular DMRS ID, which may in turn map to a particular OCC codeword and multiplexing order. For example, the mapping between the DMRS ID and the OCC codeword may be defined or indicated via the SIB from the network entity 105-a. In some cases, the network entity 105-a may monitor (e.g., listen) for the preamble. When the network entity 105-a detects the preamble, the network entity 105-a may determine that the preamble is associated with a particular DMRS ID, which in turn may be associated with an OCC codeword and a multiplexing order. Thus, in some cases, the UE 115-a may select the OCC codeword and the multiplexing order (e.g., rather than the network entity 105-a). After the UE 115-a completes a first data transmission, the UE 115-a may use a same OCC codeword and a same multiplexing order. In some examples, the UE 115-a may use a different OCC codeword (e.g., different from an OCC codeword used in the first data transmission), a different multiplexing order, or both, after the first data transmission.

The UE 115-a and the UE 115-b may each include a respective transmitter architecture 230. For example, a transmitter architecture 230 of the UE 115-a may include a set of components such as a channel coder 240 (e.g., which may be used to encode a set of source bits 235, to obtain a set of coded bits), a circular buffer 245, a bit selector 250, an interleave component 255, a scramble component 260, a modulation component 265, a resource mapper 270, one or more other transmitter components, or any combination thereof. Each component of the set of components may perform one or more corresponding procedures as described herein. Additionally, or alternatively, the UE 115-a and the UE 115-b may each include a slot counter, a cluster counter, a symbol counter, a resource element counter, or any combination thereof. Thus, the UE 115-a and the UE 115-b may support multiplexing uplink transmissions using OCCs, TBoMS, or similar aspects as described herein.

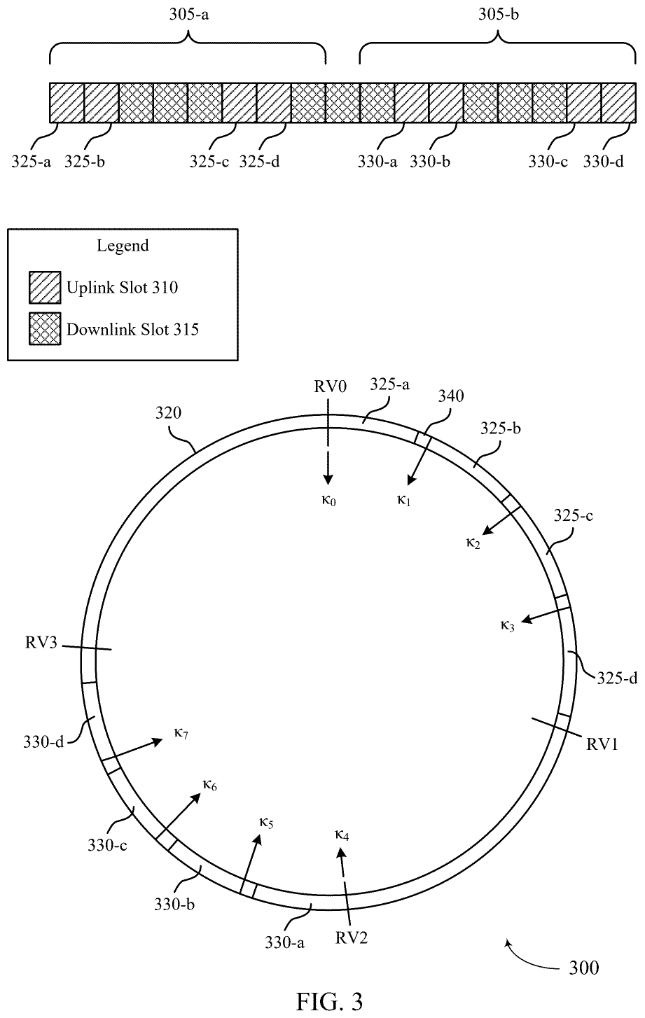

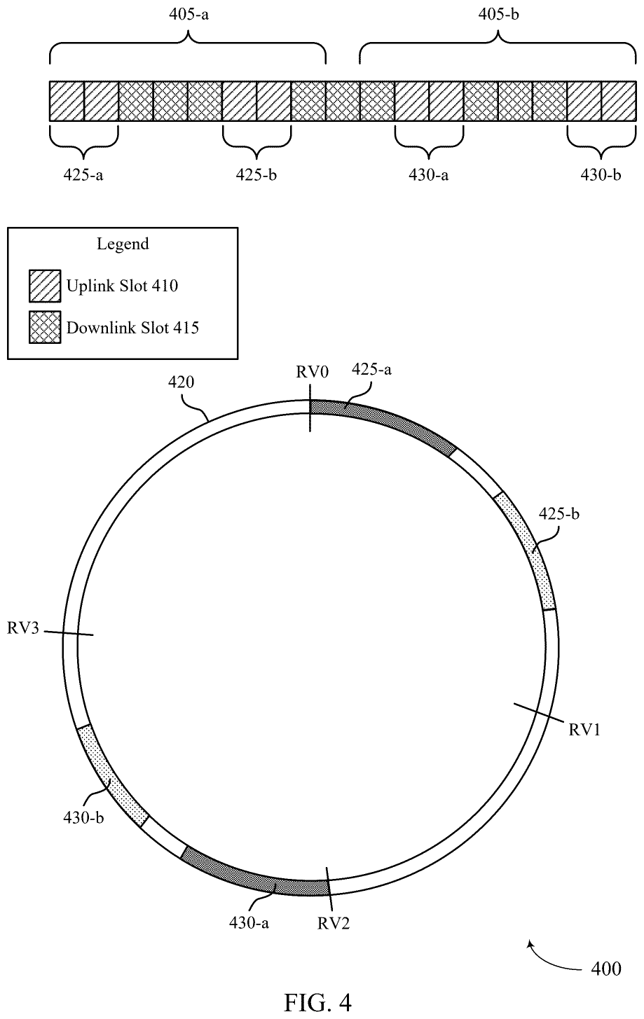

In a first alternative, the UE 115-a may modify one or more components of the transmitter architecture 230 such as the bit selector 250, the resource mapper 270, or both, to handle transmission of OCC repetitions. For example, the UE 115-a may include a slot-counter that is available for use. The slot-counter may be associated with one or more types of OCC. In some cases, the slot counter may be associated with all supported types of OCC. The UE 115-a may traverse the circular buffer 245 once per slot and may handle the OCC repetitions using the resource mapper 270 of the UE 115-a (e.g., during resource mapping). In some examples, the UE 115-a may traverse the circular buffer 245 based on a multiplexing order M used for an OCC (e.g., an OCC factor or a spreading factor). After traversing the circular buffer 245, the UE 115-a may handle each OCC-level repetition of a set of OCC-level repetitions within a respective slot. The circular buffer 245 may be an example of a circular buffer described with reference to FIG. 3 and FIG. 4.

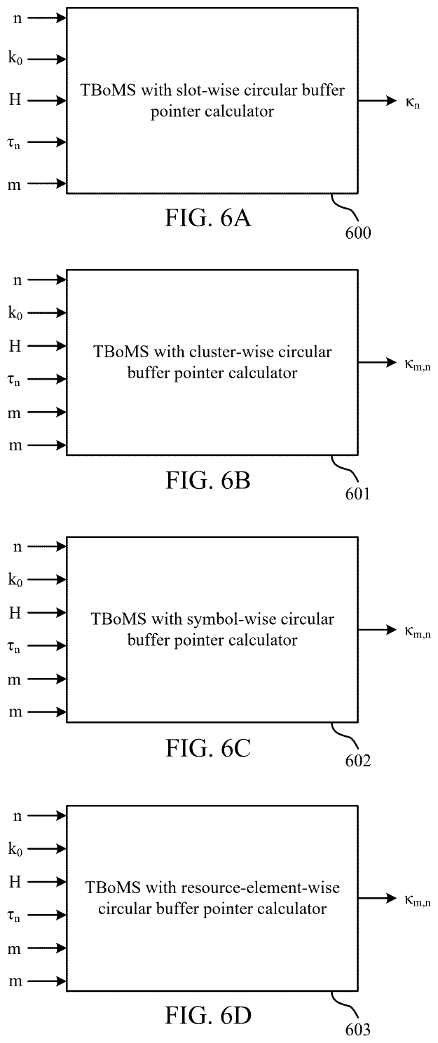

The wireless communications system 200 may support circular buffer pointer calculation based on an OCC, a multiplexing order M used for the OCC, or both. For example, the UE 115-a may calculate an index of a starting coded bit in the circular buffer 245 for an nth slot of a single TBoMS (e.g., κₙ) according to Equation (3):

$${κ}_{n} = \{ \begin{matrix}{k}_{0} & n = 0 \\ ( {κ}_{n - 1} + \frac{H}{M} + {τ}_{n - 1} ) mod {N}_{cb} & n = 1 , … , N - 1\end{matrix} \qquad ( 3 )$$

where k₀ is determined based on an RV index associated with a slot; where H is a total quantity of coded bits available for transmission of the transport block in the slot allocated for TBoMS assuming no UCI multiplexing; where M is the multiplexing order of OCC (e.g., a quantity of UEs 115 multiplexed or a spreading factor of the OCC); and where τₙ₋₁ is a quantity of filler bits that may be skipped in a bit selection step, assuming no UCI multiplexing, in the slot (n−1) allocated for TBoMS. In some cases, H may be referred to as a “budget” of coded bits for transmission of the transport block. Thus, the UE 115-a may calculate the circular buffer pointer based on the multiplexing order M of the OCC. Since the quantity of information bits may be reduced by a factor of M, the quantity of bits allocated in a slot of TBoMS may similarly be reduced by a factor of M. Thus, the UE 115-a may traverse fewer bits in the circular buffer 245 based on the value of M. In some cases, the UE 115-a may produce an output by scrambling (e.g., using the scramble component 260 of the UE 115-a) and interleaving (e.g., using the interleave component 255) the information bits based on traversing the circular buffer 245. In some examples, the UE 115-a may scramble and interleave the information bits in accordance with non-OCC or non-TBoMS transmissions (e.g., these procedures may be unmodified compared to non-OCC or non-TBoMS transmissions). In some implementations, the UE 115-a may calculate the circular buffer pointer using techniques described with reference to FIGS. 6A-6D.

After calculating a value for the circular buffer pointer, selecting a quantity of bits to transmit, and producing an output by scrambling and interleaving the information bits, the UE 115-a may modulate the output to produce modulated symbols for transmission. After modulation, the UE 115-a may apply OCC-level repetitions based on the output. For example, the UE 115-a may repeat and scale a sequence of symbols or a chunk of sequences of symbols to create M OCC copies of the sequence or chunk of sequences. The UE 115-a may then map symbols (e.g., symbols from the sequence or the chunk of sequences) to time-frequency resources (e.g., a time-frequency grid) of a transmission (e.g., an OFDM transmission) based on a type of OCC being used (e.g., FD-OCC, sub-PRB OCC, symbol-wise OCC, cluster-wise OCC, slot-wise OCC, and so on).

In a second alternative, the UE 115-a may handle transmission of OCC repetitions in the bit selector 250 of the transmitter architecture 230. The UE 115-a may include multiple counters, each counter of the multiple counters based on (e.g., depending on) a type of OCC (e.g., an OCC scheme) used for uplink transmission. In some cases, the UE 115-a may traverse a portion (e.g., a chunk) of the circular buffer 245 multiple times (e.g., M times) over an OCC unit (e.g., a slot on which an OCC has been applied). In some examples, if the UE 115-a applies an OCC across a set of slots (e.g., slot-wise OCC), the UE 115-a may refrain from advancing the circular buffer pointer until M slots have passed, where M is a multiplexing order associated with the OCC (e.g., an OCC spreading factor). During each traversal of a set of M traversals, the UE 115-a may scale (or apply a scaling on) symbols associated with bits of each traversal based on an OCC codeword associated with the OCC used by the UE 115-a. In some examples, if the UE 115-a applies the OCC across a set of clusters (e.g., cluster-wise OCC), the UE 115-a may refrain from advancing the circular buffer pointer until M clusters have passed. During each traversal of the set of M traversals, the UE 115-a may interleave the bits of each traversal using the interleave component 255. Further, the UE 115-a may scramble the bits of each traversal using the scramble component 260. In some cases, an interleaving procedure and a scrambling procedure may change or may not change compared with respective procedures corresponding to non-OCC or non-TBoMS transmissions. In some examples, the interleaving procedure and the scrambling procedure may be unaltered during each traversal of the set of M traversals. During each traversal of the set of M traversals, the UE 115-a may scale symbols associated with the bits of each traversal (e.g., during modulation, resource mapping, or both) based on an OCC codeword associated with the OCC used by the UE 115-a. In some cases, this scaling may be referred to as expanding a resource element across multiple resource elements, as described herein. Thus, the device may handle a set of OCC-level repetitions at the bit selector 250 of the UE 115-a (e.g., modifying the bit selector 250 without modifying the resource mapper 270). In some aspects, the described techniques of circular buffer traversal (e.g., bit selection, rate matching) may impact or have an effect on an output produced by scrambling and interleaving.

FIG. 3 shows an example of a circular buffer diagram 300 that supports rate matching techniques for TBoMS with OCCs in accordance with one or more aspects of the present disclosure. In some examples, the circular buffer diagram 300 may be implemented by aspects described with reference to FIGS. 1 and 2. For example, a UE 115 may include, in one or more memories, in one or more registers, or in one or more other components of the UE 115, a circular buffer 320. The UE 115 may store information in the circular buffer 320 and may read information from the circular buffer 320. The circular buffer diagram 300 may include one or more circular buffer pointers K, represented by arrows. The UE 115 may calculate a circular buffer pointer κ to read from, write to, or both, the circular buffer 320. In some implementations, the UE 115-a may calculate the circular buffer pointer using techniques described with reference to FIGS. 6A-6D.

The circular buffer diagram 300 may include a first repetition 305-a and a second repetition 305-b (e.g., TBoMS repetitions, which may correspond to respective RV bundles). The first repetition 305-a and the second repetition 305-b may each include one or more uplink slots 310, one or more downlink slots 315, or both. The one or more uplink slots 310 may refer to other resource elements such as clusters. The UE 115 may transmit one or more uplink messages via the one or more uplink slots 310 based on information that it reads from the circular buffer 320. For example, the UE 115 may calculate a circular buffer pointer κ₀ and may determine a quantity of bits to transmit from the circular buffer. The UE 115 may subsequently transmit information 325-a, beginning at the circular buffer pointer κ₀, via a first uplink slot 310. Then, the UE 115 may advance the circular buffer pointer to κ₁, and may read and transmit, via a second uplink slot 310, information 325-b, beginning at the circular buffer pointer κ₁. The UE 115 may likewise advance the circular buffer pointer, read, and transmit information 325-c and information 325-d, thereby completing a transmission for the first repetition 305-a. Additionally, or alternatively, the UE 115 may apply similar techniques to transmit a set of information 330 (e.g., information 330-a, information 330-b, information 330-c, and information 330-d) via uplink slots 310 corresponding to the second repetition 305-b. In some cases, the circular buffer may include respective sets of one or more filler bits 340 (e.g., in between each set of information 325 of the buffer).

As described herein, the UE 115 may receive one or more control messages from a network entity, where the one or more control messages may indicate an OCC multiplexing order and/or a type of OCC multiplexing. For a set of source information bits associated with an uplink transmission, the UE 115 may perform channel coding to obtain a set of encoded information bits (e.g., which may be referred to as encoded bits and/or coded bits), which may be stored in a buffer of the UE. The UE 115 may select, from the circular buffer, a quantity of bits for respective transmission time intervals (e.g., respective slots) associated with the uplink transmission. For example, the UE 115 may select, for each slot of a set of multiple slots, a quantity of encoded bits for the uplink transmission, where the quantity of bits for each transmission time interval (e.g., each slot) selected from the buffer may be based on respective starting encoded bits (e.g., respective indices of starting encoded bits, buffer pointer κₙ). In such cases, the respective starting encoded bit (e.g., corresponding to buffer pointer κₙ) may be based on a total quantity of encoded bits for each transmission time interval (e.g., slot) and the OCC multiplexing order. In some aspects, OCC repetitions in accordance with the type of OCC multiplexing and OCC multiplexing order may be achieved during resource mapping (e.g., to time/frequency resources) prior to sending the uplink transmission.

Additionally, or alternatively, the UE 115 may select a quantity of encoded bits for a set of multiple units (e.g., slots, clusters, symbols, REs, or the like) associated with the uplink transmission. In such cases, for each unit of the set of units, a respective quantity of encoded bits may be selected a quantity of times that corresponds to the OCC multiplexing order. Here, the respective starting encoded bit (corresponding to the buffer pointer κₙ) for the encoded bits stored in the circular buffer may advance after the respective quantity of encoded bits is selected the quantity of times corresponding to the OCC multiplexing order (e.g., for an OCC multiplexing order M, the index of the starting encoded bit may only advance after bits have been selected from the buffer M times (e.g., for M units)). In such cases, the OCC repetitions may be achieved based on the selection of the quantity of encoded bits for the set of multiple units. The UE 115 may transmit the uplink transmission to a network entity. The uplink transmission may include one or more repetitions of each respective quantity of encoded bits based on the respective quantities of encoded bits in accordance with the type of OCC multiplexing and an OCC codeword assignment.

FIG. 4 shows an example of a circular buffer diagram 400 that supports rate matching techniques for TBoMS with OCCs in accordance with one or more aspects of the present disclosure. In some examples, the circular buffer diagram 400 may be implemented by aspects described with reference to FIGS. 1 and 2. For example, a UE 115 may include, in one or more memories, in one or more registers, or in one or more other components of the UE 115, a circular buffer 420. The UE 115 may store information in the circular buffer 420 and may read information from the circular buffer 420. Similarly, the circular buffer diagram 400 may implement one or more aspects of the circular buffer diagram 300. For example, the UE 115 may calculate a circular buffer pointer to read from, write to, or both, the circular buffer 420. In some implementations, the UE 115-a may calculate the circular buffer pointer using techniques described with reference to FIGS. 6A-6D.

The circular buffer diagram 400 may include a first repetition 405-a and a second repetition 405-b (e.g., TBoMS repetitions or RV bundles). The first repetition 405-a and the second repetition 405-b may each include one or more uplink slots 410, one or more downlink slots 415, or both. The one or more uplink slots 410 may refer to other units such as clusters. The UE 115 may transmit one or more uplink messages via the one or more uplink slots 410 based on information that it reads from the circular buffer 420. For example, the UE 115 may calculate a circular buffer pointer and may determine a quantity of bits to transmit from the circular buffer. The UE 115 may subsequently transmit information 425-a, beginning at the circular buffer pointer, via a first uplink slot 410. Then, the UE 115 may refrain from advancing the circular buffer pointer (e.g., the circular buffer pointer may remain an originally-calculated circular buffer pointer). Thus, the UE 115 may read and transmit, via a second uplink slot 410, the information 425-b, beginning at the circular buffer pointer. The UE may transmit the information 425-b a quantity of times (and via a quantity of slots) equal to the OCC multiplexing order. The UE 115 may then advance the circular buffer pointer and may read and transmit information 425-b a quantity of times (e.g., twice, in accordance with an OCC multiplexing order of 2), thereby completing a transmission for the first repetition 405-a. Additionally, or alternatively, the UE 115 may apply similar techniques to transmit a set of information 430 (e.g., information 430-a and information 430-b) via uplink slots 410 corresponding to the second repetition 405-b.

In some implementations, at the beginning of each repetition 405, the UE 115 may refresh the RV associated with the repetition 405. Thus, an RV may change for a next repetition 405 (e.g., the RV may change between the first repetition 405-a and the second repetition 405-b. In some cases, a starting bit index for bit selection may be associated with the circular buffer 420. In some examples, if the UE 115 is not performing UCI multiplexing, the starting bit index may be precomputed (e.g., prior to the first repetition 405-a). In such examples, the UE 115 may perform the bit selection, rate matching, and interleaving on a per-slot basis.

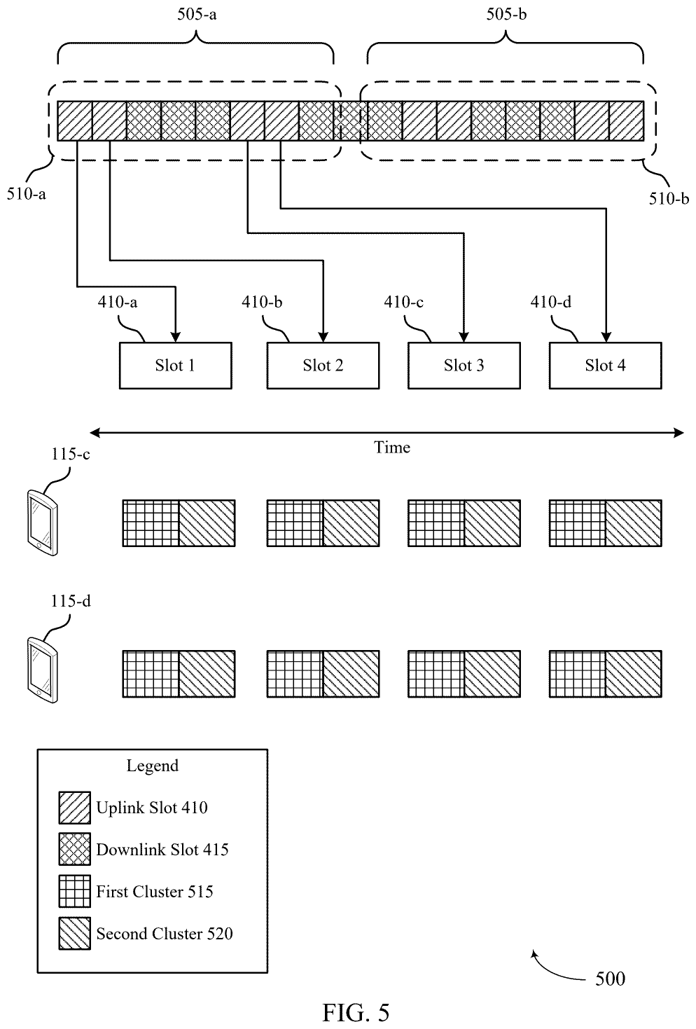

FIG. 5 shows an example of a transmission diagram 500 that supports rate matching techniques for TBoMS with OCCs in accordance with one or more aspects of the present disclosure. In some cases, the transmission diagram 500 may implement or be implemented by aspects of the wireless communications system 100 or the wireless communications system 200. For example, the transmission diagram 500 may include one or more UEs 115 (e.g., a UE 115-c and a UE 115-c) which may be examples of the corresponding devices as described herein. In the following description, although some operations are described to be performed by the UE 115-c, these operations may also be performed by the UE 115-d in some examples.

In some cases, the UE 115-c may calculate a total quantity of symbols N_{sym} (e.g., OFDM symbols) allocated to the UE 115-c in a TBoMS repetition by multiplying a quantity of slots Nₛₗₒₜ by a quantity of symbols per slot N_{sym_s}. The UE 115-c may divide the quantity of symbols N_{sym} into a quantity of clusters Nc. Each cluster of the quantity of clusters Nc may include a group of symbols (e.g., symbols “bunched” together). For example, each cluster may include a quantity of symbols per cluster N_{sym_c}. A total quantity of clusters Nc may be calculated as N_{sym} divided-by N_{sym_c}. Additionally, or alternatively, the UE 115-c may calculate the total quantity of symbols N_{sym} by multiplying Nc by N_{sym_c}. In some examples, in accordance with a cluster-wise OCC, the UE 115-c may apply the OCC across a group of symbols rather than slots. Thus, the UE 115-c may expand one cluster across M clusters, where M is a multiplexing order of the cluster-wise OCC. In some cases, grouping multiple symbols together (e.g., into clusters) may be associated with mini-slots (e.g., relatively short slots to reduce system latency). Thus, the quantity of symbols per cluster N_{sym_c} may be associated with the aspect of mini-slots (e.g., clusters, or groups of symbols, may be referred to as mini-slots). In some examples, a UE 115-c may apply cluster-wise OCC over a smaller time interval compared to slot-wise OCC, reducing or avoiding impairments or distortion (e.g., doppler).

In some examples, the UE 115-c and the UE 115-d may transmit and receive a set of messages via one or more resource elements. For example, a first set of resource elements 510-a may include a set of uplink slots 410 and a set of downlink slots 415. Similarly, second set of resource elements 510-b may include a set of uplink slots 410 and a set of downlink slots 415. Each uplink slot 410 may include a quantity of clusters (e.g., two or four). The UE 115-c may transmit one or more TBoMS repetitions 505. For example, the UE 115-c may transmit a first TBoMS repetitions 505-a, which may include the first set of resource elements 510-a. Additionally, or alternatively, the UE 115-c may transmit a second TBoMS repetition 505-b, which may include the second set of resource elements 510-b. A TBoMS repetition may be referred to as an RV bundle, an instance of TBoMS, or both.

In some implementations, the UE 115-c may handle the third level of repetitions (e.g., the OCC-level) on a per-cluster basis, or at a cluster-level (e.g., rather than on a per-slot basis, or at a slot-level). As an example, an OCC (e.g., a cluster-wise OCC) may be associated with a multiplexing order M=2, and a TBoMS may include four slots, and each slot may include two clusters. In such an example, the UE 115-c may transmit the first TBoMS repetition 505-a (e.g., a first RV bundle) and the second TBoMS repetition 505-b according to the OCC. The first TBoMS repetition 505-a may include a set of uplink slots 410 and the second TBoMS repetition 505-b may include a set of uplink slots 410 (e.g., two repetitions of four slots each, in accordance with the multiplexing order M=2). The UE 115-c may transmit a set of uplink messages using each uplink slot 410 of a set of uplink slots 410. Each uplink message of the set of uplink messages may be cover coded (e.g., transmitted with an OCC). In some cases, the UE 115-c may transmit, in each uplink slot 410 of the set of uplink slots 410, a set of clusters (e.g., two clusters). For example, the UE 115-c may transmit, via the first uplink slot 410-a, a first cluster 515 and a second cluster 520, which may be respective copies of an information cluster (e.g., a ‘+’ cluster and a ‘+’ cluster, in accordance with an OCC codeword [1, 1]). The UE 115-c may likewise transmit respective first clusters 515 and respective second clusters 520 via the second uplink slot 410-b, the third uplink slot 410-c, and the fourth uplink slot 410-d.

In some cases, the UE 115-d may transmit, via the set of uplink slots 410, a set of clusters (e.g., a set of first clusters 515 and a set of second clusters 520), in accordance with the OCC. However, the UE 115-d may transmit each first cluster 515 as a copy of an information cluster and may transmit each second cluster 520 as an “inverted” copy of the information cluster in accordance with the OCC (e.g., a ‘+’ cluster and a ‘-’ cluster, in accordance with an OCC codeword [1,−1]). Thus, the UE 115-c and the UE 115-d may perform multiplexing on a same set of resources using the OCC.

A set of four UEs 115 may apply similar techniques for an OCC multiplexing order of four (e.g., four clusters on each slot). For example, the UE 115-c may transmit a set of four clusters in the first uplink slot 410-a according to an OCC codeword [1, 1, 1, 1]. Similarly, the UE 115-d may transmit a set of four clusters in the first uplink slot 410-a according to an OCC codeword [1,−1, 1,−1], and so on. Thus, each UE 115 of a set of UEs 115 may expand a first cluster across a set of four clusters (e.g., in accordance with the OCC multiplexing order of 4).

In some implementations, the UE 115-c may transmit each cluster of a set of clusters based on a circular buffer as described with reference to FIGS. 3 and 4. For example, the UE 115-c may transmit, via a first uplink slot 410-a, a first cluster 515 that includes a set of information beginning at a circular buffer pointer of the circular buffer. The UE 115-c may refrain from advancing the circular buffer pointer, and may transmit, via the first uplink slot 410-a, a second cluster 520 that includes a same set of information beginning at the circular buffer pointer. The UE 115-c may transmit the same set of information a quantity of times equal to a multiplexing order of an OCC applied by the UE 115-c. Additionally, or alternatively, the UE 115-c may advance the circular buffer pointer and may similarly transmit a second set of information in each cluster corresponding to a second uplink slot 410-b, and so on. In some implementations, the UE 115-a may calculate the circular buffer pointer using techniques described with reference to FIGS. 6A-6D.

FIGS. 6A, 6B, 6C, and 6D illustrate respective examples of calculators 600, 601, 602, and 603, respectively, that support rate matching techniques for TBoMS with OCCs in accordance with one or more aspects of the present disclosure. In some cases, the calculators may implement or be implemented by aspects of the wireless communications system 100, the wireless communications system 200, the circular buffer diagram 300, the circular buffer diagram 400, or the transmission diagram 500. For example, a UE 115 may include one or more of the calculators, and may use the one or more of the calculators in a transmission architecture. In some cases, each calculator may produce an output value based on the set of one or more inputs (e.g., according to Equation (3)). The output value of each calculator may be referred to as a circular buffer pointer used for techniques described herein with reference to FIGS. 1-5.

FIG. 6A illustrates a first calculator 600. The first calculator 600 may support TBoMS with a slot-wise circular buffer pointer (e.g., referred to as a TBoMS with slot-wise circular buffer pointer calculator). The first calculator 600 may receive a set of one or more inputs. The set of one or more inputs may include a slot identifier (or number) n corresponding to a slot allocated for TBoMS. Additionally, or alternatively, the set of one or more inputs may include k₀, an RV index associated with the slot. Further, the set of one or more inputs may include H, a total quantity of coded bits available for transmission of a transport block in the slot (assuming no UCI multiplexing). The value H may be based on a quantity of information (e.g., bits) to be transmitted. In some cases, the set of one or more inputs may include In, or τₙ₋₁, which may indicate a quantity of filler bits that may be skipped (e.g., by the UE 115) in a bit selection step in the slot n or n−1 (assuming no UCI multiplexing). In some examples, the set of one or more inputs may include M, a multiplexing order of an OCC assigned to the UE 115.

In some implementations, the UE 115 may transmit one or more messages according to multiple types of OCCs (e.g., multiple OCC schemes). For example, to improve coherence and to avoid distortion (e.g., doppler), the UE 115 may apply OCCs that are different from a slot-wise OCC. In some cases, the UE 115 may support circular buffer traversal schemes for multiple OCC configurations or schemes (e.g., cluster-wise OCC, symbol-wise OCC, and so on).

FIG. 6B illustrates a second calculator 601. The second calculator 601 may support TBoMS with a cluster-wise circular buffer pointer (e.g., referred to as a TBoMS with slot-wise circular buffer pointer calculator). In some cases, the second calculator 601 may use a set of one or more inputs, which may include the input values corresponding to the first calculator 600 described with reference to FIG. 6A. Further, the set of one or more inputs corresponding to the second calculator 601 may include a cluster number m, which may identify a cluster that the UE 115 is to transmit (e.g., a cluster identifier m).

In some implementations, the second calculator 601 may consider which cluster of a set of clusters that the UE 115 is to transmit and may output a circular buffer pointer accordingly. For example, for cluster-wise OCC, the UE 115 may traverse the circular buffer within a slot. Within a slot, the UE 115 may move the circular buffer pointer after every M clusters in the circular buffer. Thus, the UE 115 may include a cluster counter that indicates the cluster identifier m (or the cluster number m). In some cases, the UE 115 may identify a quantity of clusters, a cluster identifier, a cluster number, or any combination thereof, based on the cluster counter.

FIG. 6C illustrates a third calculator 602. The third calculator 602 may support TBoMS with a symbol-wise circular buffer pointer (e.g., referred to as a TBoMS with symbol-wise circular buffer pointer calculator). In some cases, the third calculator 602 may use a set of one or more inputs, which may include the input values corresponding to the first calculator 600 described with reference to FIG. 6A. Further, the set of one or more inputs corresponding to the third calculator 602 may include a symbol number m, which may identify a symbol that the UE 115 is to transmit (e.g., a symbol identifier m).

In some implementations, the third calculator 602 may consider which symbol of a set of symbols that the UE 115 is to transmit and may output a circular buffer pointer accordingly. For example, for symbol-wise OCC, the UE 115 may traverse the circular buffer within a slot. Within a slot, the UE 115 may move the circular buffer pointer after every M symbols in the circular buffer. Thus, the UE 115 may include a symbol counter that indicates the symbol identifier m (or the symbol number m). In some cases, the UE 115 may identify a quantity of symbols, a symbol identifier, a symbol number, or any combination thereof, based on the symbol counter. Additionally, or alternatively, the UE 115 may use the third calculator 602 to calculate a circular buffer pointer for traversing a circular buffer for cluster-wise OCC.

FIG. 6D illustrates a fourth calculator 603. The fourth calculator 603 may support TBoMS with a resource-element-wise circular buffer pointer (e.g., referred to as a TBoMS with resource-element-wise circular buffer pointer calculator). In some cases, the fourth calculator 603 may use a set of one or more inputs, which may include the input values corresponding to the first calculator 600 described with reference to FIG. 6A. Further, the set of one or more inputs corresponding to the fourth calculator 603 may include a resource element number m, which may identify a resource element that the UE 115 is to transmit (e.g., a resource element identifier m). The resource element number m may correspond to any resource element, such as a group of symbols, a cluster, a slot, or a combination thereof.

In some implementations, the fourth calculator 603 may consider which resource element of a set of resource elements that the UE 115 is to transmit and may output a circular buffer pointer accordingly. For example, for FD-OCC, the UE 115 may traverse the circular buffer within a slot. Within a slot, the UE 115 may move the circular buffer pointer after every M resource elements in the circular buffer. Thus, the UE 115 may include a resource element counter (which may be referred to as a resource counter) that indicates the resource element identifier m (or the resource element number m). In some cases, the UE 115 may identify a quantity of resource elements, a resource element identifier, a resource element number, or any combination thereof, based on the resource element counter. Additionally, or alternatively, the UE 115 may use the fourth calculator 603 to calculate a circular buffer pointer for traversing a circular buffer for cluster-wise OCC, symbol-wise OCC, or both.

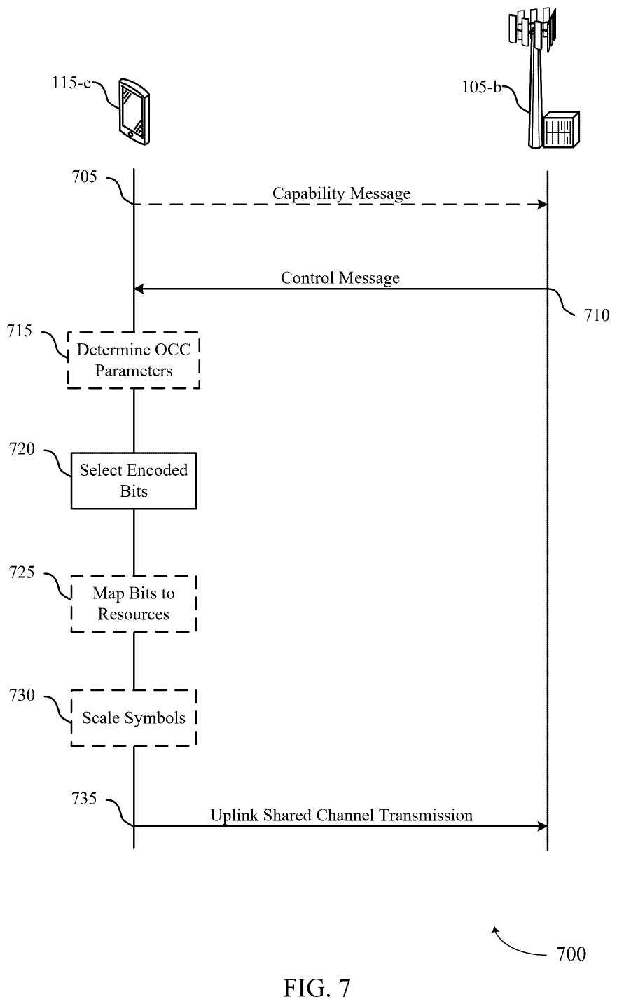

FIG. 7 shows an example of a process flow 700 that supports rate matching techniques for TBoMS with OCCs in accordance with one or more aspects of the present disclosure. The process flow 700 includes a UE 115-e and a network entity 105-b, which may be examples of the corresponding devices as described with respect to FIGS. 1-6. In the following description of the process flow 700, the operations between the UE 115-e and the network entity 105-b may be performed in a different order than the example order shown. Some operations may also be omitted from the process flow 700, and other operations may be added to the process flow 700. Further, although some operations or signaling may be shown to occur at different times for discussion purposes, these operations may actually occur at the same time.

At 705, the UE 115-e may transmit, to the network entity 105-b, a capability message indicating one or more capabilities of the UE 115-e to support OCC multiplexing.

At 710, the UE 115-e may receive, from the network entity 105-b, a control message indicating an OCC multiplexing order, a type of OCC multiplexing, or both. The UE 115-e may receive the control message based on the one or more capabilities. In some cases, the control message may indicate both the OCC multiplexing order and the type of OCC multiplexing. In some cases, the type of OCC multiplexing may be an example of a slot-based OCC type, a symbol-based OCC type, a cluster-based OCC type, a frequency-domain OCC type, a time-domain OCC type, a sub-physical resource block (PRB) OCC type, or any combination thereof.

At 715, the UE 115-e may determine an OCC codeword assignment based on a mapping between a demodulation reference signal identifier and the OCC codeword assignment. Additionally, or alternatively, the UE 115-e may determine the OCC multiplexing order based on the OCC codeword assignment.

At 720, the UE 115-e may select a quantity of encoded bits for each slot of multiple slots associated with an uplink shared channel transmission. The quantity of encoded bits may be selected using a respective starting encoded bit that is based on a total quantity of encoded bits for each slot and the OCC multiplexing order. In some cases, the UE 115-e may determine an index of each respective starting encoded bit based on dividing the total quantity of encoded bits allocated in a slot by the OCC multiplexing order. The UE 115-e may select the quantity of encoded bits based on the index of each respective starting encoded bit. In some examples, the UE 115-e may calculate the index of each respective starting encoded bit based on a redundancy version index, the total quantity of encoded bits allocated in a slot, the OCC multiplexing order, and a quantity of filler bits. The UE 115-e may select the quantity of bits for each slot based on counting the multiple slots. In some cases, multiple encoded bits from which the quantity of encoded bits for each slot (or other unit) are selected may be associated with a circular buffer of the UE 115-e.

In some implementations, the UE 115-e may select a quantity of encoded bits for multiple units associated with the uplink shared channel transmission, where, for each unit of the multiple units, a respective quantity of encoded bits may be selected a quantity of times that corresponds to the OCC multiplexing order. In some cases, a respective starting encoded bit advances after the respective quantity of encoded bits is selected the quantity of times corresponding to the OCC multiplexing order. The UE 115-e may select the quantity of encoded bits for the multiple units based on advancing the respective starting encoded bit. In some cases, the UE 115-e may advance an index of each respective starting encoded bit based on selecting the respective quantity of encoded bits for each unit. The UE 115-e may advance the index after the respective quantities of encoded bits for a quantity of units corresponding to the OCC multiplexing order are selected. In some examples, the UE 115-e may determine the index of each respective starting encoded bit based on a redundancy version index, a total quantity of encoded bits, the OCC multiplexing order, a quantity of filler bits, an index of the unit, or any combination thereof.

At 725, the UE 115-e may interleave, scramble, and modulate the quantity of encoded bits for each slot after the quantity of encoded bits is selected. In some implementations, respective sets of modulated symbols may be based on interleaving, scrambling, and modulating the respective quantity of encoded bits for each unit after the respective quantities of encoded bits are selected. The UE 115-e may map the interleaved, scrambled, and modulated quantity of encoded bits to one or more resources associated with each slot of the multiple slots based on the type of the OCC multiplexing. In some cases, the UE 115-e may apply an OCC codeword to obtain a quantity of one or more repetitions that corresponds to the OCC multiplexing order. The OCC codeword may be based on the OCC codeword assignment. In some cases, each unit may be an example of or may include a slot, a cluster, a symbol, a resource element, or any combination thereof. Each unit may be based on the type of OCC multiplexing.

At 730, the UE 115-e may scale the respective sets of modulated symbols associated with each respective quantity of encoded bits using an OCC codeword that is based on the OCC codeword assignment. In some cases, the one or more repetitions may be based on the scaling. In some cases, the interleaving and the scrambling may be unaltered when the respective starting encoded bit advances after the respective quantity of encoded bits is selected the quantity of times corresponding to the OCC multiplexing order. For example, during a traversal of a circular buffer a quantity of times for selecting coded bits (e.g., traversing the circular buffer M times), the interleaving and the scrambling may be unaltered (e.g., remain the same). Further, the scrambling and interleaving may change for the next M traversals of the circular buffer for selecting coded bits, but the scrambling and interleaving will not change during the next M traversals of the circular buffer.

At 735, the UE 115-e may transmit the uplink shared channel transmission to the network entity 105-b. The uplink shared channel transmission may include the one or more repetitions of the quantity of encoded bits via the multiple slots based on the type of OCC multiplexing and the OCC codeword assignment. In some cases, the one or more repetitions may be based on the mapping. In some implementations, the uplink shared channel transmission may include one or more repetitions of each respective quantity of encoded bits based on scaling each respective quantity of encoded bits in accordance with the type of OCC multiplexing and an OCC codeword assignment.

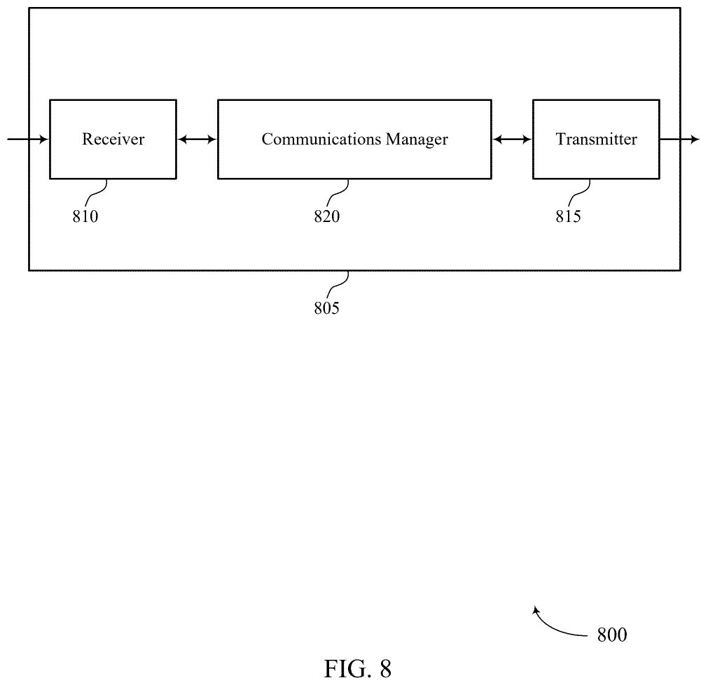

FIG. 8 shows a block diagram 800 of a device 805 that supports rate matching techniques for TBoMS with OCCs in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to rate matching techniques for TBoMS with OCCs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to rate matching techniques for TBoMS with OCCs). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of rate matching techniques for TBoMS with OCCs as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving, from a network entity, a control message indicating an OCC (OCC) multiplexing order, a type of OCC multiplexing, or both. The communications manager 820 is capable of, configured to, or operable to support a means for selecting a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order. The communications manager 820 is capable of, configured to, or operable to support a means for transmitting the uplink shared channel transmission to the network entity, where the uplink shared channel transmission includes one or more repetitions of the quantity of encoded bits via the set of multiple slots based on the type of OCC multiplexing and an OCC codeword assignment.

Additionally, or alternatively, the communications manager 820 may support wireless communications in accordance with examples as disclosed herein. For example, the communications manager 820 is capable of, configured to, or operable to support a means for receiving, from a network entity, a control message indicating an OCC (OCC) multiplexing order, a type of OCC multiplexing, or both. The communications manager 820 is capable of, configured to, or operable to support a means for selecting a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit. The communications manager 820 is capable of, configured to, or operable to support a means for transmitting the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for rate matching for TBoMS with OCCs, which may result in reduced power consumption, more efficient utilization of communication resources, among other advantages.

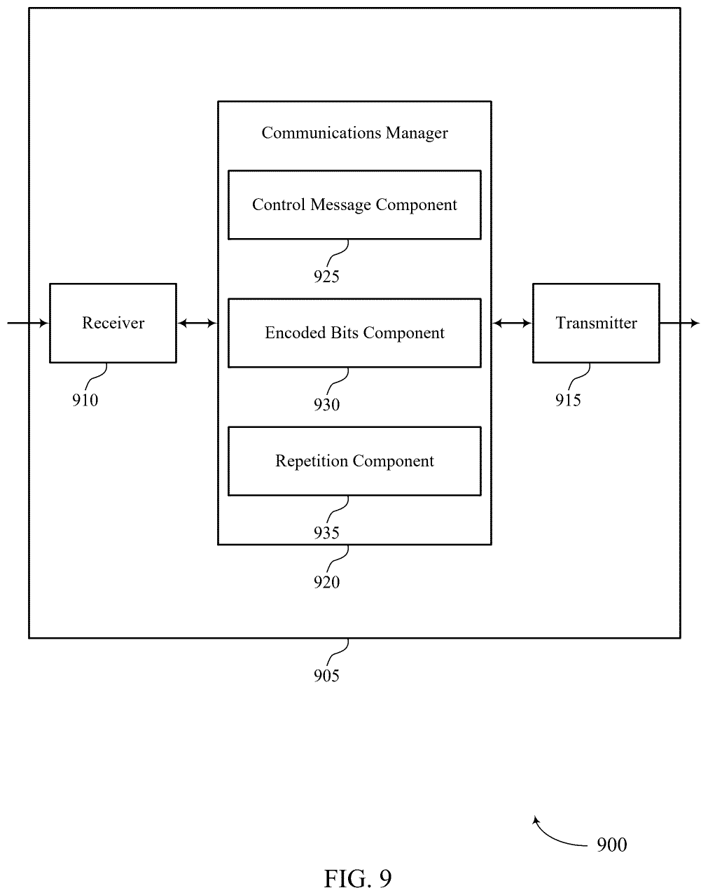

FIG. 9 shows a block diagram 900 of a device 905 that supports rate matching techniques for TBoMS with OCCs in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to rate matching techniques for TBoMS with OCCs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to rate matching techniques for TBoMS with OCCs). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of rate matching techniques for TBoMS with OCCs as described herein. For example, the communications manager 920 may include a control message component 925, an encoded bits component 930, a repetition component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The control message component 925 is capable of, configured to, or operable to support a means for receiving, from a network entity, a control message indicating an OCC multiplexing order, a type of OCC multiplexing, or both. The encoded bits component 930 is capable of, configured to, or operable to support a means for selecting a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order. The repetition component 935 is capable of, configured to, or operable to support a means for transmitting the uplink shared channel transmission to the network entity, where the uplink shared channel transmission includes one or more repetitions of the quantity of encoded bits via the set of multiple slots based on the type of OCC multiplexing and an OCC codeword assignment.

Additionally, or alternatively, the communications manager 920 may support wireless communications in accordance with examples as disclosed herein. The control message component 925 is capable of, configured to, or operable to support a means for receiving, from a network entity, a control message indicating an OCC multiplexing order, a type of OCC multiplexing, or both. The encoded bits component 930 is capable of, configured to, or operable to support a means for selecting a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit. The repetition component 935 is capable of, configured to, or operable to support a means for transmitting the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment.

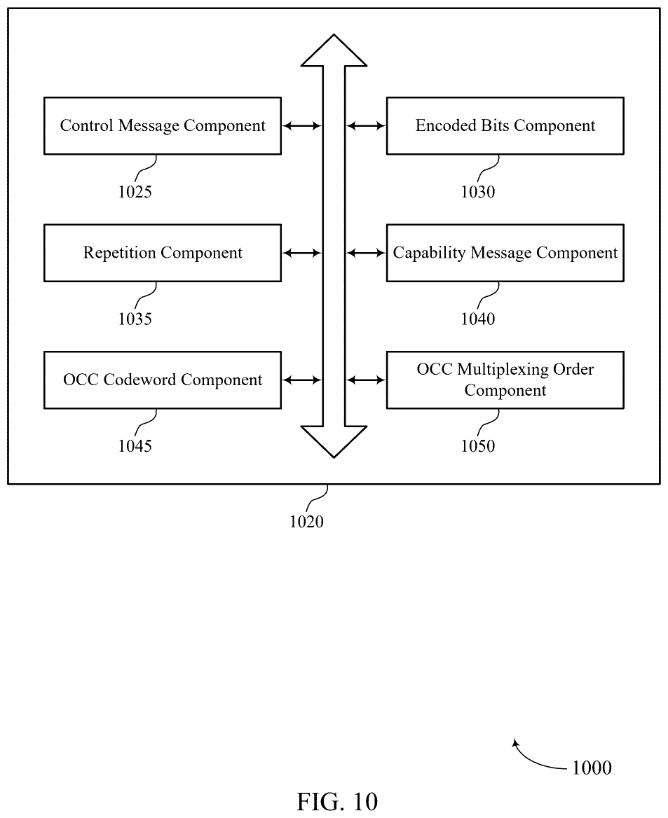

FIG. 10 shows a block diagram 1000 of a communications manager 1020 that supports rate matching techniques for TBoMS with OCCs in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of rate matching techniques for TBoMS with OCCs as described herein. For example, the communications manager 1020 may include a control message component 1025, an encoded bits component 1030, a repetition component 1035, a capability message component 1040, a OCC codeword component 1045, a OCC multiplexing order component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The control message component 1025 is capable of, configured to, or operable to support a means for receiving, from a network entity, a control message indicating an OCC multiplexing order, a type of OCC multiplexing, or both. The encoded bits component 1030 is capable of, configured to, or operable to support a means for selecting a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order. The repetition component 1035 is capable of, configured to, or operable to support a means for transmitting the uplink shared channel transmission to the network entity, where the uplink shared channel transmission Includes one or more repetitions of the quantity of encoded bits via the set of multiple slots based on the type of OCC multiplexing and an OCC codeword assignment.

In some examples, the quantity of encoded bits for each slot is interleaved, and the encoded bits component 1030 is capable of, configured to, or operable to support a means for mapping the interleaved, scrambled, and modulated quantity of encoded bits to one or more resources associated with each slot of the set of multiple slots based on the type of OCC multiplexing, where the one or more repetitions are based on the mapping.

In some examples, the repetition component 1035 is capable of, configured to, or operable to support a means for applying an OCC codeword to obtain a quantity of the one or more repetitions that corresponds to the OCC multiplexing order, where the OCC codeword is based on the OCC codeword assignment.

In some examples, the encoded bits component 1030 is capable of, configured to, or operable to support a means for determining an index of each respective starting encoded bit based on dividing the total quantity of encoded bits allocated in a slot by the OCC multiplexing order, where the quantity of encoded bits is selected based on the index of each respective starting encoded bit.

In some examples, the index of each respective starting encoded bit is calculated based on a redundancy version index, the total quantity of encoded bits allocated in a slot, the OCC multiplexing order, and a quantity of filler bits.

In some examples, selecting the quantity of bits for each slot is based on counting the set of multiple slots.

In some examples, the capability message component 1040 is capable of, configured to, or operable to support a means for transmitting, to the network entity, a capability message indicating one or more capabilities of the UE to support OCC multiplexing, where receiving the control message is based on the one or more capabilities.

In some examples, the OCC codeword component 1045 is capable of, configured to, or operable to support a means for determining the OCC codeword assignment based on a mapping between a demodulation reference signal identifier and the OCC codeword assignment. In some examples, the OCC multiplexing order component 1050 is capable of, configured to, or operable to support a means for determining the OCC multiplexing order based on the OCC codeword assignment.

In some examples, the control message indicates both the OCC multiplexing order and the type of OCC multiplexing.

In some examples, the type of OCC multiplexing includes a slot-based OCC type, a symbol-based OCC type, a cluster-based OCC type, a frequency-domain OCC type, a time-domain OCC type, a sub-physical resource block (PRB) OCC type, or any combination thereof.

In some examples, a set of multiple encoded bits from which the quantity of encoded bits for each slot are selected are associated with a circular buffer of the UE.

Additionally, or alternatively, the communications manager 1020 may support wireless communications in accordance with examples as disclosed herein. In some examples, the control message component 1025 is capable of, configured to, or operable to support a means for receiving, from a network entity, a control message indicating an OCC multiplexing order, a type of OCC multiplexing, or both. In some examples, the encoded bits component 1030 is capable of, configured to, or operable to support a means for selecting a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit. In some examples, the repetition component 1035 is capable of, configured to, or operable to support a means for transmitting the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment.

In some examples, respective sets of modulated symbols may be based on interleaving, scrambling, and modulating the respective quantity of encoded bits for each unit after the respective quantities of encoded bits are selected (e.g., at the repetition component 1035). Further, the repetition component 1035 is capable of, configured to, or operable to support a means for scaling the respective sets of modulated symbols associated with each respective quantity of encoded bits using an OCC codeword that is based on the OCC codeword assignment, where the one or more repetitions are based on the scaling.

In some examples, the interleaving and the scrambling are unaltered when the respective starting encoded bit advances after the respective quantity of encoded bits is selected the quantity of times corresponding to the OCC multiplexing order.

In some examples, the encoded bits component 1030 is capable of, configured to, or operable to support a means for advancing an index of each respective starting encoded bit based on selecting the respective quantity of encoded bits for each unit, where the index is advanced after the respective quantities of encoded bits for a quantity of units corresponding to the OCC multiplexing order are selected.

In some examples, the encoded bits component 1030 is capable of, configured to, or operable to support a means for determining the index of each respective starting encoded bit based on a redundancy version index, a total quantity of encoded bits, the OCC multiplexing order, a quantity of filler bits, an index of the unit, or any combination thereof.

In some examples, the capability message component 1040 is capable of, configured to, or operable to support a means for transmitting, to the network entity, a capability message indicating one or more capabilities of the UE to support OCC multiplexing, where receiving the control message is based on the one or more capabilities.

In some examples, the OCC codeword component 1045 is capable of, configured to, or operable to support a means for determining the OCC codeword assignment based on a mapping between a demodulation reference signal identifier and the OCC codeword assignment. In some examples, the OCC multiplexing order component 1050 is capable of, configured to, or operable to support a means for determining the OCC multiplexing order based on the OCC codeword assignment.

In some examples, the control message indicates both the OCC multiplexing order and the type of OCC multiplexing.

In some examples, selecting the respective quantity of encoded bits for each unit is based on counting each unit of the set of multiple units.

In some examples, each unit includes a slot, a cluster, a symbol, a resource element, or any combination thereof.

In some examples, each unit is based on the type of OCC multiplexing.

In some examples, the type of OCC multiplexing includes a slot-based OCC type, a symbol-based OCC type, a cluster-based OCC type, a frequency-domain OCC type, a time-domain OCC type, a sub-physical resource block (PRB) OCC type, or any combination thereof.

In some examples, a set of multiple encoded bits from which the quantity of encoded bits for each unit are selected are associated with a circular buffer of the UE.

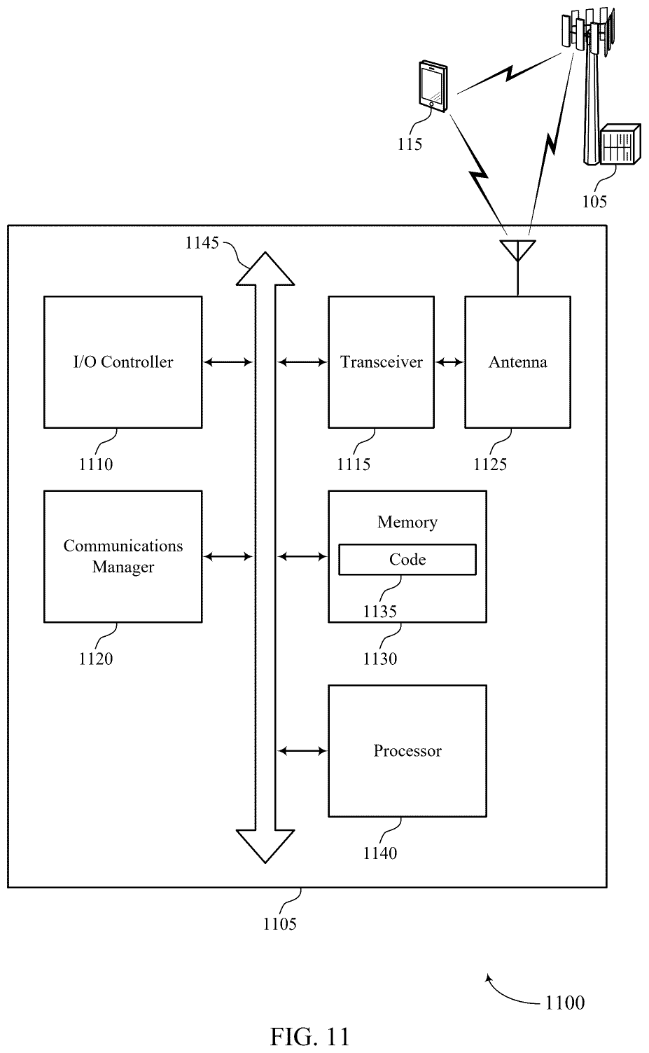

FIG. 11 shows a diagram of a system 1100 including a device 1105 that supports rate matching techniques for TBoMS with OCCs in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting rate matching techniques for TBoMS with OCCs). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving, from a network entity, a control message indicating an OCC multiplexing order, a type of OCC multiplexing, or both. The communications manager 1120 is capable of, configured to, or operable to support a means for selecting a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order. The communications manager 1120 is capable of, configured to, or operable to support a means for transmitting the uplink shared channel transmission to the network entity, where the uplink shared channel transmission includes one or more repetitions of the quantity of encoded bits via the set of multiple slots based on the type of OCC multiplexing and an OCC codeword assignment.

Additionally, or alternatively, the communications manager 1120 may support wireless communications in accordance with examples as disclosed herein. For example, the communications manager 1120 is capable of, configured to, or operable to support a means for receiving, from a network entity, a control message indicating an OCC multiplexing order, a type of OCC multiplexing, or both. The communications manager 1120 is capable of, configured to, or operable to support a means for selecting a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit. The communications manager 1120 is capable of, configured to, or operable to support a means for transmitting the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment.

By including or configuring the communications manager 1120 in accordance with examples as described herein, the device 1105 may support techniques for rate matching techniques for TBoMS with OCCs, which may result in improved communication reliability, reduced latency, reduced power consumption, more efficient utilization of communication resources, improved coordination between devices, longer battery life, improved utilization of processing capability, among other advantages.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of rate matching techniques for TBoMS with OCCs as described herein, or the at least one processor 1140 and the at least one memory 1130 may be otherwise configured to, individually or collectively, perform or support such operations.

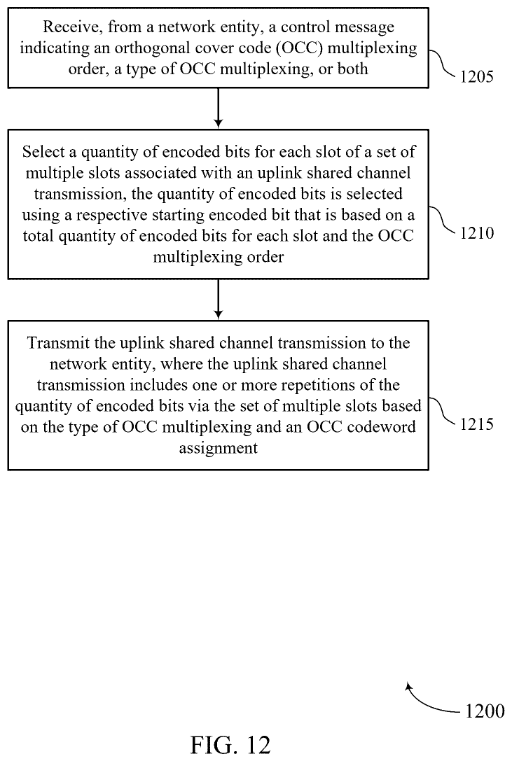

FIG. 12 shows a flowchart illustrating a method 1200 that supports rate matching techniques for TBoMS with OCCs in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, a control message indicating an OCC multiplexing order, a type of OCC multiplexing, or both. The operations of 1205 may be performed in accordance with examples as disclosed herein. In some examples, aspects of the operations of 1205 may be performed by a control message component 1025 as described with reference to FIG. 10.

At 1210, the method may include selecting a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order. The operations of 1210 may be performed in accordance with examples as disclosed herein. In some examples, aspects of the operations of 1210 may be performed by an encoded bits component 1030 as described with reference to FIG. 10.

At 1215, the method may include transmitting the uplink shared channel transmission to the network entity, where the uplink shared channel transmission includes one or more repetitions of the quantity of encoded bits via the set of multiple slots based on the type of OCC multiplexing and an OCC codeword assignment. The operations of 1215 may be performed in accordance with examples as disclosed herein. In some examples, aspects of the operations of 1215 may be performed by a repetition component 1035 as described with reference to FIG. 10.

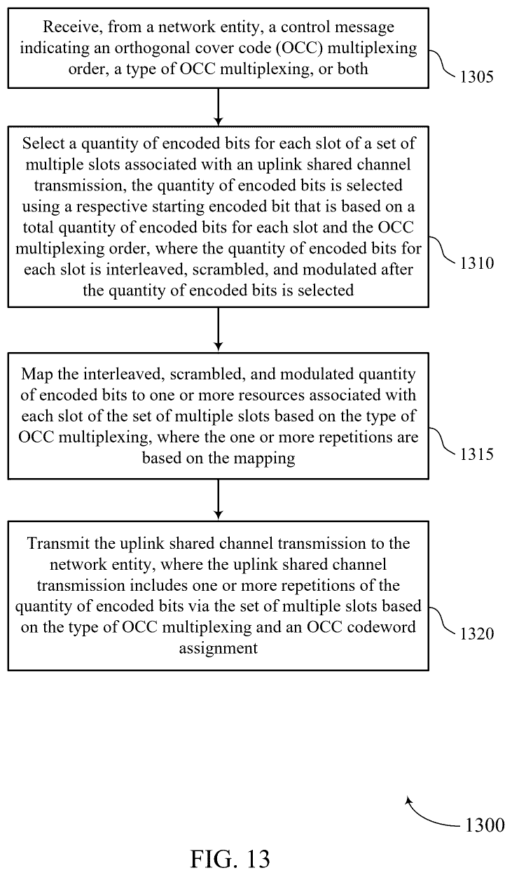

FIG. 13 shows a flowchart illustrating a method 1300 that supports rate matching techniques for TBoMS with OCCs in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, a control message indicating an OCC multiplexing order, a type of OCC multiplexing, or both. The operations of 1305 may be performed in accordance with examples as disclosed herein. In some examples, aspects of the operations of 1305 may be performed by a control message component 1025 as described with reference to FIG. 10.

At 1310, the method may include selecting a quantity of encoded bits for each slot of a set of multiple slots associated with an uplink shared channel transmission, the quantity of encoded bits is selected using a respective starting encoded bit that is based on a total quantity of encoded bits for each slot and the OCC multiplexing order, where the quantity of encoded bits for each slot is interleaved, scrambled, and modulated after the quantity of encoded bits is selected. The operations of 1310 may be performed in accordance with examples as disclosed herein. In some examples, aspects of the operations of 1310 may be performed by an encoded bits component 1030 as described with reference to FIG. 10.

At 1315, the method may include mapping the interleaved, scrambled, and modulated quantity of encoded bits to one or more resources associated with each slot of the set of multiple slots based on the type of OCC multiplexing, where the one or more repetitions are based on the mapping. The operations of 1315 may be performed in accordance with examples as disclosed herein. In some examples, aspects of the operations of 1315 may be performed by an encoded bits component 1030 as described with reference to FIG. 10.

At 1320, the method may include transmitting the uplink shared channel transmission to the network entity, where the uplink shared channel transmission includes one or more repetitions of the quantity of encoded bits via the set of multiple slots based on the type of OCC multiplexing and an OCC codeword assignment. The operations of 1320 may be performed in accordance with examples as disclosed herein. In some examples, aspects of the operations of 1320 may be performed by a repetition component 1035 as described with reference to FIG. 10.

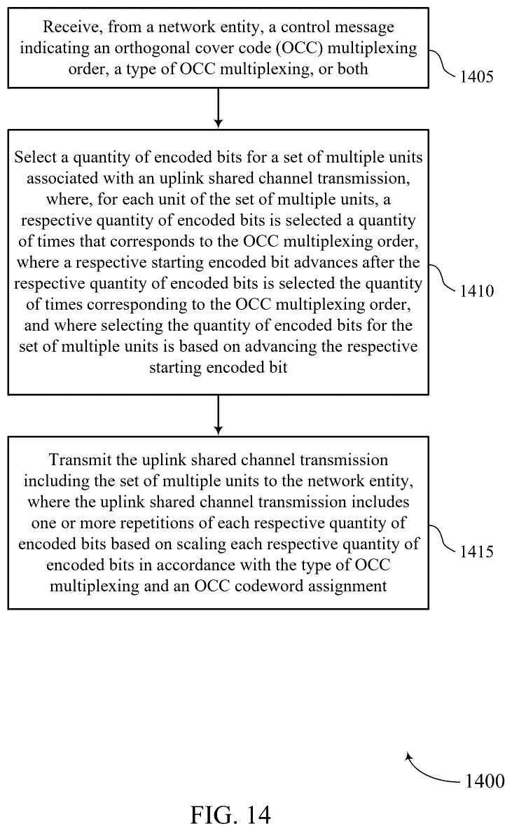

FIG. 14 shows a flowchart illustrating a method 1400 that supports rate matching techniques for TBoMS with OCCs in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a control message indicating an OCC multiplexing order, a type of OCC multiplexing, or both. The operations of 1405 may be performed in accordance with examples as disclosed herein. In some examples, aspects of the operations of 1405 may be performed by a control message component 1025 as described with reference to FIG. 10.

At 1410, the method may include selecting a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit. The operations of 1410 may be performed in accordance with examples as disclosed herein. In some examples, aspects of the operations of 1410 may be performed by an encoded bits component 1030 as described with reference to FIG. 10.

At 1415, the method may include transmitting the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment. The operations of 1415 may be performed in accordance with examples as disclosed herein. In some examples, aspects of the operations of 1415 may be performed by a repetition component 1035 as described with reference to FIG. 10.

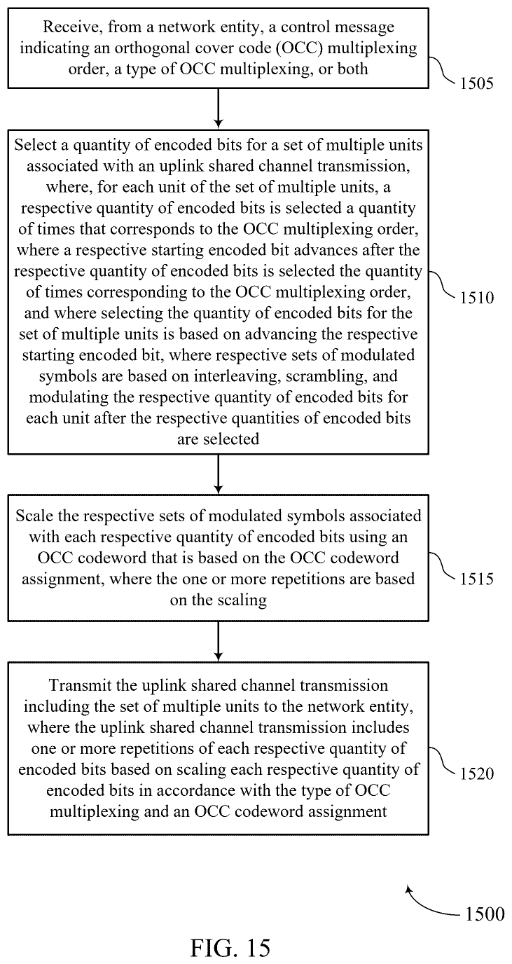

FIG. 15 shows a flowchart illustrating a method 1500 that supports rate matching techniques for TBoMS with OCCs in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a control message indicating an OCC multiplexing order, a type of OCC multiplexing, or both. The operations of 1505 may be performed in accordance with examples as disclosed herein. In some examples, aspects of the operations of 1505 may be performed by a control message component 1025 as described with reference to FIG. 10.

At 1510, the method may include selecting a quantity of encoded bits for a set of multiple units associated with an uplink shared channel transmission, where, for each unit of the set of multiple units, a respective quantity of encoded bits is selected a quantity of times that corresponds to the OCC multiplexing order, where a respective starting encoded bit advances after the respective quantity of encoded bits is selected the quantity of times corresponding to the OCC multiplexing order, and where selecting the quantity of encoded bits for the set of multiple units is based on advancing the respective starting encoded bit, where respective sets of modulated symbols are based on interleaving, scrambling, and modulating the respective quantity of encoded bits for each unit after the respective quantities of encoded bits are selected. The operations of 1510 may be performed in accordance with examples as disclosed herein. In some examples, aspects of the operations of 1510 may be performed by an encoded bits component 1030 as described with reference to FIG. 10.

At 1515, the method may include scaling the respective sets of modulated symbols associated with each respective quantity of encoded bits using an OCC codeword that is based on the OCC codeword assignment, where the one or more repetitions are based on the scaling. The operations of 1515 may be performed in accordance with examples as disclosed herein. In some examples, aspects of the operations of 1515 may be performed by a repetition component 1035 as described with reference to FIG. 10.

At 1520, the method may include transmitting the uplink shared channel transmission including the set of multiple units to the network entity, where the uplink shared channel transmission includes one or more repetitions of each respective quantity of encoded bits based on scaling each respective quantity of encoded bits in accordance with the type of OCC multiplexing and an OCC codeword assignment. The operations of 1520 may be performed in accordance with examples as disclosed herein. In some examples, aspects of the operations of 1520 may be performed by a repetition component 1035 as described with reference to FIG. 10.

The following provides an overview of aspects of the present disclosure:
Aspect 1: A method for wireless communications at a UE, comprising: receiving, from a network entity, a control message indicating an OCC multiplexing order, a type of OCC multiplexing, or both; selecting a quantity of encoded bits for each slot of a plurality of slots associated with an uplink shared channel transmission, the quantity of encoded bits is selected using a respective starting encoded bit that is based at least in part on a total quantity of encoded bits for each slot and the OCC multiplexing order; and transmitting the uplink shared channel transmission to the network entity, wherein the uplink shared channel transmission comprises one or more repetitions of the quantity of encoded bits via the plurality of slots based at least in part on the type of OCC multiplexing and an OCC codeword assignment.
Aspect 2: The method of aspect 1, wherein the quantity of encoded bits for each slot is interleaved, scrambled, and modulated after the quantity of encoded bits is selected, the method further comprising: mapping the interleaved, scrambled, and modulated quantity of encoded bits to one or more resources associated with each slot of the plurality of slots based at least in part on the type of OCC multiplexing, wherein the one or more repetitions are based at least in part on the mapping.
Aspect 3: The method of aspect 2, further comprising: applying an OCC codeword to obtain a quantity of the one or more repetitions that corresponds to the OCC multiplexing order, wherein the OCC codeword is based at least in part on the OCC codeword assignment.
Aspect 4: The method of any of aspects 1 through 3, further comprising: determining an index of each respective starting encoded bit based at least in part on dividing the total quantity of encoded bits allocated in a slot by the OCC multiplexing order, wherein the quantity of encoded bits is selected based at least in part on the index of each respective starting encoded bit.
Aspect 5: The method of aspect 4, wherein the index of each respective starting encoded bit is calculated based at least in part on a redundancy version index, the total quantity of encoded bits allocated in a slot, the OCC multiplexing order, and a quantity of filler bits.
Aspect 6: The method of any of aspects 1 through 5, wherein selecting the quantity of bits for each slot is based at least in part on counting the plurality of slots.
Aspect 7: The method of any of aspects 1 through 6, further comprising: transmitting, to the network entity, a capability message indicating one or more capabilities of the UE to support orthogonal cover code multiplexing, wherein receiving the control message is based at least in part on the one or more capabilities.
Aspect 8: The method of any of aspects 1 through 7, further comprising: determining the OCC codeword assignment based at least in part on a mapping between a demodulation reference signal identifier and the OCC codeword assignment; and determining the OCC multiplexing order based at least in part on the OCC codeword assignment.
Aspect 9: The method of any of aspects 1 through 8, wherein the control message indicates both the OCC multiplexing order and the type of OCC multiplexing.
Aspect 10: The method of any of aspects 1 through 9, wherein the type of OCC multiplexing comprises a slot-based OCC type, a symbol-based OCC type, a cluster-based OCC type, a frequency-domain OCC type, a time-domain OCC type, a sub-PRB OCC type, or any combination thereof.
Aspect 11: The method of any of aspects 1 through 10, wherein a plurality of encoded bits from which the quantity of encoded bits for each slot are selected are associated with a circular buffer of the UE.
Aspect 12: A method for wireless communications at a UE, comprising: receiving, from a network entity, a control message indicating an OCC multiplexing order, a type of OCC multiplexing, or both; selecting a quantity of encoded bits for a plurality of units associated with an uplink shared channel transmission, wherein, for each unit of the plurality of units, a respective quantity of encoded bits is selected a quantity of times that corresponds to the OCC multiplexing order, wherein a respective starting encoded bit advances after the respective quantity of encoded bits is selected the quantity of times corresponding to the OCC multiplexing order, and wherein selecting the quantity of encoded bits for the plurality of units is based at least in part on advancing the respective starting encoded bit; and transmitting the uplink shared channel transmission including the plurality of units to the network entity, wherein the uplink shared channel transmission comprises one or more repetitions of each respective quantity of encoded bits based at least in part on scaling each respective quantity of encoded bits in accordance with the type of OCC multiplexing and an OCC codeword assignment.
Aspect 13: The method of aspect 12, wherein respective sets of modulated symbols are based at least in part on interleaving, scrambling, and modulating the respective quantity of encoded bits for each unit after the respective quantities of encoded bits are selected, the method further comprising: scaling the respective sets of modulated symbols associated with each respective quantity of encoded bits using an OCC codeword that is based at least in part on the OCC codeword assignment, wherein the one or more repetitions are based at least in part on the scaling.
Aspect 14: The method of aspect 13, wherein the interleaving and the scrambling are unaltered when the respective starting encoded bit advances after the respective quantity of encoded bits is selected the quantity of times corresponding to the OCC multiplexing order.
Aspect 15: The method of any of aspects 12 through 14, further comprising: advancing an index of each respective starting encoded bit based at least in part on selecting the respective quantity of encoded bits for each unit, wherein the index is advanced after the respective quantities of encoded bits for a quantity of units corresponding to the OCC multiplexing order are selected.
Aspect 16: The method of aspect 15, further comprising: determining the index of each respective starting encoded bit based at least in part on a redundancy version index, a total quantity of encoded bits, the OCC multiplexing order, a quantity of filler bits, an index of the unit, or any combination thereof.
Aspect 17: The method of any of aspects 12 through 16, further comprising: transmitting, to the network entity, a capability message indicating one or more capabilities of the UE to support orthogonal cover code multiplexing, wherein receiving the control message is based at least in part on the one or more capabilities.
Aspect 18: The method of any of aspects 12 through 17, further comprising: determining the OCC codeword assignment based at least in part on a mapping between a demodulation reference signal identifier and the OCC codeword assignment; and determining the OCC multiplexing order based at least in part on the OCC codeword assignment.
Aspect 19: The method of any of aspects 12 through 18, wherein the control message indicates both the OCC multiplexing order and the type of OCC multiplexing.
Aspect 20: The method of any of aspects 12 through 19, wherein selecting the respective quantity of encoded bits for each unit is based at least in part on counting each unit of the plurality of units.
Aspect 21: The method of any of aspects 12 through 20, wherein each unit comprises a slot, a cluster, a symbol, a resource element, or any combination thereof.
Aspect 22: The method of any of aspects 12 through 21, wherein each unit is based at least in part on the type of OCC multiplexing.
Aspect 23: The method of any of aspects 12 through 22, wherein the type of OCC multiplexing comprises a slot-based OCC type, a symbol-based OCC type, a cluster-based OCC type, a frequency-domain OCC type, a time-domain OCC type, a sub-PRB OCC type, or any combination thereof.
Aspect 24: The method of any of aspects 12 through 23, wherein a plurality of encoded bits from which the quantity of encoded bits for each unit are selected are associated with a circular buffer of the UE.
Aspect 25: A UE for wireless communications, comprising one or more memories storing processor-executable code, and one or more processors coupled with the one or more memories and individually or collectively operable to execute the code to cause the UE to perform a method of any of aspects 1 through 11.
Aspect 26: A UE for wireless communications, comprising at least one means for performing a method of any of aspects 1 through 11.
Aspect 27: A non-transitory computer-readable medium storing code for wireless communications, the code comprising instructions executable by one or more processors to perform a method of any of aspects 1 through 11.
Aspect 28: A UE for wireless communications, comprising one or more memories storing processor-executable code, and one or more processors coupled with the one or more memories and individually or collectively operable to execute the code to cause the UE to perform a method of any of aspects 12 through 24.
Aspect 29: A UE for wireless communications, comprising at least one means for performing a method of any of aspects 12 through 24.
Aspect 30: A non-transitory computer-readable medium storing code for wireless communications, the code comprising instructions executable by one or more processors to perform a method of any of aspects 12 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, a control message indicating an orthogonal cover code (OCC) multiplexing order, a type of OCC multiplexing, or both;
select a quantity of encoded bits for each slot of a plurality of slots associated with an uplink shared channel transmission, the quantity of encoded bits is selected using a respective starting encoded bit that is based at least in part on a total quantity of encoded bits for each slot and the OCC multiplexing order; and
transmit the uplink shared channel transmission to the network entity, wherein the uplink shared channel transmission comprises one or more repetitions of the quantity of encoded bits via the plurality of slots based at least in part on the type of OCC multiplexing and an OCC codeword assignment.

2. The UE of claim 1, wherein the quantity of encoded bits for each slot is interleaved, scrambled, and modulated after the quantity of encoded bits is selected, and the one or more processors are individually or collectively further operable to execute the code to cause the UE to:
map the interleaved, scrambled, and modulated quantity of encoded bits to one or more resources associated with each slot of the plurality of slots based at least in part on the type of OCC multiplexing, wherein the one or more repetitions are based at least in part on the mapping.

3. The UE of claim 2, wherein the one or more processors are individually or collectively further operable to execute the code to cause the UE to:
apply an OCC codeword to obtain a quantity of the one or more repetitions that corresponds to the OCC multiplexing order, wherein the OCC codeword is based at least in part on the OCC codeword assignment.

4. The UE of claim 1, wherein the one or more processors are individually or collectively further operable to execute the code to cause the UE to:
determine an index of each respective starting encoded bit based at least in part on dividing the total quantity of encoded bits allocated in a slot by the OCC multiplexing order, wherein the quantity of encoded bits is selected based at least in part on the index of each respective starting encoded bit.

5. The UE of claim 4, wherein the index of each respective starting encoded bit is calculated based at least in part on a redundancy version index, the total quantity of encoded bits allocated in a slot, the OCC multiplexing order, and a quantity of filler bits.

6. The UE of claim 1, wherein selecting the quantity of bits for each slot is based at least in part on counting the plurality of slots.

7. The UE of claim 1, wherein the one or more processors are individually or collectively further operable to execute the code to cause the UE to:
transmit, to the network entity, a capability message indicating one or more capabilities of the UE to support orthogonal cover code multiplexing, wherein receiving the control message is based at least in part on the one or more capabilities.

8. The UE of claim 1, wherein the one or more processors are individually or collectively further operable to execute the code to cause the UE to:
determine the OCC codeword assignment based at least in part on a mapping between a demodulation reference signal identifier and the OCC codeword assignment; and
determine the OCC multiplexing order based at least in part on the OCC codeword assignment.

9. A user equipment (UE), comprising:
one or more memories storing processor-executable code; and
one or more processors coupled with the one or more memories and individually or collectively operable to execute the code to cause the UE to:
receive, from a network entity, a control message indicating an orthogonal cover code (OCC) multiplexing order, a type of OCC multiplexing, or both;
select a quantity of encoded bits for a plurality of units associated with an uplink shared channel transmission, wherein, for each unit of the plurality of units, a respective quantity of encoded bits is selected a quantity of times that corresponds to the OCC multiplexing order, wherein a respective starting encoded bit advances after the respective quantity of encoded bits is selected the quantity of times corresponding to the OCC multiplexing order, and wherein selecting the quantity of encoded bits for the plurality of units is based at least in part on advancing the respective starting encoded bit; and
transmit the uplink shared channel transmission including the plurality of units to the network entity, wherein the uplink shared channel transmission comprises one or more repetitions of each respective quantity of encoded bits based at least in part on scaling each respective quantity of encoded bits in accordance with the type of OCC multiplexing and an OCC codeword assignment.

10. The UE of claim 9, wherein respective sets of modulated symbols are based at least in part on interleaving, scrambling, and modulating the respective quantity of encoded bits for each unit after the respective quantities of encoded bits are selected, and the one or more processors are individually or collectively further operable to execute the code to cause the UE to:
scale the respective sets of modulated symbols associated with each respective quantity of encoded bits using an OCC codeword that is based at least in part on the OCC codeword assignment, wherein the one or more repetitions are based at least in part on the scaling.

11. The UE of claim 10, wherein the interleaving and the scrambling are unaltered when the respective starting encoded bit advances after the respective quantity of encoded bits is selected the quantity of times corresponding to the OCC multiplexing order.

12. The UE of claim 9, wherein the one or more processors are individually or collectively further operable to execute the code to cause the UE to:
advance an index of each respective starting encoded bit based at least in part on selecting the respective quantity of encoded bits for each unit, wherein the index is advanced after the respective quantities of encoded bits for a quantity of units corresponding to the OCC multiplexing order are selected.

13. The UE of claim 12, wherein the one or more processors are individually or collectively further operable to execute the code to cause the UE to:
determine the index of each respective starting encoded bit based at least in part on a redundancy version index, a total quantity of encoded bits, the OCC multiplexing order, a quantity of filler bits, an index of the unit, or any combination thereof.

14. The UE of claim 9, wherein the one or more processors are individually or collectively further operable to execute the code to cause the UE to:
transmit, to the network entity, a capability message indicating one or more capabilities of the UE to support orthogonal cover code multiplexing, wherein receiving the control message is based at least in part on the one or more capabilities.

15. The UE of claim 9, wherein the one or more processors are individually or collectively further operable to execute the code to cause the UE to:
determine the OCC codeword assignment based at least in part on a mapping between a demodulation reference signal identifier and the OCC codeword assignment; and
determine the OCC multiplexing order based at least in part on the OCC codeword assignment.

16. The UE of claim 9, wherein the control message indicates both the OCC multiplexing order and the type of OCC multiplexing, and wherein the type of OCC multiplexing comprises a slot-based OCC type, a symbol-based OCC type, a cluster-based OCC type, a frequency-domain OCC type, a time-domain OCC type, a sub-physical resource block (PRB) OCC type, or any combination thereof.

17. The UE of claim 9, wherein selecting the respective quantity of encoded bits for each unit is based at least in part on counting each unit of the plurality of units.

18. The UE of claim 9, wherein each unit comprises a slot, a cluster, a symbol, a resource element, or any combination thereof, and wherein each unit is based at least in part on the type of OCC multiplexing.

19. The UE of claim 9, wherein a plurality of encoded bits from which the quantity of encoded bits for each unit are selected are associated with a circular buffer of the UE.

20. A method for wireless communications at a user equipment (UE), comprising:
receiving, from a network entity, a control message indicating an orthogonal cover code (OCC) multiplexing order, a type of OCC multiplexing, or both;
selecting a quantity of encoded bits for a plurality of units associated with an uplink shared channel transmission, wherein, for each unit of the plurality of units, a respective quantity of encoded bits is selected a quantity of times that corresponds to the OCC multiplexing order, wherein a respective starting encoded bit advances after the respective quantity of encoded bits is selected the quantity of times corresponding to the OCC multiplexing order, and wherein selecting the quantity of encoded bits for the plurality of units is based at least in part on advancing the respective starting encoded bit; and
transmitting the uplink shared channel transmission including the plurality of units to the network entity, wherein the uplink shared channel transmission comprises one or more repetitions of each respective quantity of encoded bits based at least in part on scaling each respective quantity of encoded bits in accordance with the type of OCC multiplexing and an OCC codeword assignment.
